(19) United States
(12) Patent Application Publication
(10) Pub. No.: US 2024/0385438 A1
(43) Pub. Date: Nov. 21, 2024

(54) Holographic system and pupil expander therefor

(71) Applicant: Envisics Ltd, Milton Keynes (GB)

(72) Inventors: Daniel Burnham, Milton Keynes (GB); Timothy Smeeton, Milton Keynes (GB)

(21) Appl. No.: 18/687,222

(22) PCT Filed: Sep. 20, 2022
(86) PCT No.: PCT/EP2022/076088

§ 371 Date: Feb. 27, 2024

(30) Foreign Application Priority Data
Sep. 21, 2021 (GB) 2113436.6

(51) Int. Cl. G02B 27/01; B60K 35/235; G02B 6/06; G02B 6/26; G02F 1/1362; G03H 1/00; G03H 1/22

(52) U.S. Cl. CPC G02B 27/0103; B60K 35/235; G02B 6/06; G02B 6/262; G02B 27/0179; G03H 1/0005; G03H 1/2205; G03H 1/2294; B60K 2360/29; B60K 2360/334; B60K 2360/336; G02B 2027/0105; G02B 2027/0123; G02B 2027/0187; G02F 1/136277; G03H 2001/221; G03H 2001/2239; G03H 2225/22

(57) ABSTRACT

A holographic system comprises a spatial light modulator and a pupil expander. The spatial light modulator is arranged to display a hologram of an image and to output spatially modulated light encoded with the hologram. In embodiments, the pupil expander comprises a plurality of optical fibres, each optical fibre having an input end and an output end. The pupil expander is arranged so that spatially modulated light output by the spatial light modulator is coupled into the input end of each optical fibre and output from the output end thereof to a viewing area. Each of the plurality of optical fibres is arranged to propagate the received spatially modulated light received at its input end so as to expand an exit pupil of the system in a first dimension, typically corresponding to a dimension of the viewing area.

### CROSS-REFERENCE TO RELATED APPLICATIONS

The present application is a 35 U.S.C. § 371 National Stage Application that claims priority to Patent Cooperation Treaty App. No. PCT/EP2022/076088, titled “Holographic System And Pupil Expander Therefor,” filed on Sep. 20, 2022, and currently pending; PCT/EP2022/076088 claims priority to U.K. App. GB 2113436.6, titled “Holographic System And Pupil Expander Therefor,” filed on Sep. 21, 2021, and currently pending. The entire contents of Patent Cooperation Treaty App. No. PCT/EP2022/076088 and U.K. App. GB 2113436.6 are incorporated herein by reference.

### FIELD

The present disclosure relates to a holographic system. More specifically, the present disclosure relates to a holographic imaging system and a method of holographic imaging. Some embodiments relate to a picture generating unit and a head-up display. Some embodiments relate to a method of pupil expansion and an arrangement for pupil expansion for a viewing area of a holographic system.

### BACKGROUND AND INTRODUCTION

Light scattered from an object contains both amplitude and phase information. This amplitude and phase information can be captured on, for example, a photosensitive plate by well-known interference techniques to form a holographic recording, or “hologram”, comprising interference fringes. The hologram may be reconstructed by illumination with suitable light to form a two-dimensional or three-dimensional holographic reconstruction, or replay image, representative of the original object.

Computer-generated holography may numerically simulate the interference process. A computer-generated hologram may be calculated by a technique based on a mathematical transformation such as a Fresnel or Fourier transform. These types of holograms may be referred to as Fresnel/Fourier transform holograms or simply Fresnel/Fourier holograms. A Fourier hologram may be considered a Fourier domain/plane representation of the object or a frequency domain/plane representation of the object. A computer-generated hologram may also be calculated by coherent ray tracing or a point cloud technique, for example.

A computer-generated hologram may be encoded on a spatial light modulator arranged to modulate the amplitude and/or phase of incident light. Light modulation may be achieved using electrically-addressable liquid crystals, optically-addressable liquid crystals or micro-mirrors, for example.

A spatial light modulator typically comprises a plurality of individually-addressable pixels which may also be referred to as cells or elements. The light modulation scheme may be binary, multilevel or continuous. Alternatively, the device may be continuous (i.e. is not comprised of pixels) and light modulation may therefore be continuous across the device. The spatial light modulator may be reflective meaning that modulated light is output in reflection. The spatial light modulator may equally be transmissive meaning that modulated light is output in transmission.

A holographic projector may be provided using the system described herein. Such projectors have found application in head-up displays, “HUD”

### SUMMARY

Aspects of the present disclosure are defined in the appended independent claims.

Broadly, the present disclosure relates to image projection. It relates to a method of image projection and an image projector which comprises a display device. The present disclosure also relates to a projection system comprising the image projector and a viewing system, in which the image projector projects or relays light from the display device to the viewing system. The present disclosure is equally applicable to a monocular and binocular viewing system. The viewing system may comprise a viewer's eye or eyes. The viewing system comprises an optical element having optical power (e.g., lens/es of the human eye) and a viewing plane (e.g., retina of the human eye/s). The projector may be referred to as a ‘light engine’. The display device and the image formed (or perceived) using the display device are spatially separated from one another. The image is formed, or perceived by a viewer, on a display plane. In some embodiments, the image is a virtual image and the display plane may be referred to as a virtual image plane. In other embodiments, the image is a real image formed by holographic reconstruction and the image is projected or relayed to the viewing plane. The image is formed by illuminating a diffractive pattern (e.g., hologram) displayed on the display device.

The display device comprises pixels. The pixels of the display device diffract light. In accordance with well-understood optics, the magnitude of the maximum diffraction angle is determined by the size of the pixels (and other factors such as the wavelength of the light).

In embodiments, the display device is a spatial light modulator such as liquid crystal on silicon (“LCOS”) spatial light modulator (SLM). Light propagates over a range of diffraction angles (for example, from zero to the maximum diffractive angle) from the LCOS, towards a viewing entity/system such as a camera or an eye. In some embodiments, magnification techniques may be used to increase the range of available diffraction angles beyond the conventional maximum diffraction angle of an LCOS.

In some examples, an image (formed from the displayed hologram) is propagated to the eyes. For example, spatially modulated light of an intermediate holographic reconstruction/image formed either in free space or on a screen or other light receiving surface between the display device and the viewer, may be propagated to the viewer.

In other examples, the hologram itself is propagated to the eyes. That is, spatially modulated light of the hologram is propagated to the eyes. A real or virtual image may be perceived by the viewer. It may also be said that light encoded with the hologram is propagated directly to the eye(s). In these embodiments, there is no intermediate holographic reconstruction/image formed between the display device and the viewer. It is sometimes said that, in these embodiments, the lens of the eye performs a hologram-to-image conversion or transform. The projection system, or light engine, may be configured so that the viewer effectively looks directly at the display device.

In accordance with the principles of well-understood optics, the range of angles of light propagating from a display device that can be viewed, by an eye or other viewing entity/system, varies with the distance between the display device and the viewing entity. At a 1 metre viewing distance, for example, only a small range of angles from an LCOS can propagate through an eye's pupil to form an image at the retina for a given eye position. The range of angles of light rays that are propagated from the display device, which can successfully propagate through an eye's pupil to form an image at the retina for a given eye position, determines the portion of the image that is ‘visible’ to the viewer. In other words, not all parts of the image are visible from any one point on the viewing plane (e.g., any one eye position within a viewing window such as eye-motion box.)

In some embodiments, the image perceived by a viewer is a virtual image that appears upstream of the display device—that is, the viewer perceives the image as being further away from them than the display device. Conceptually, it may therefore be considered that the viewer is looking at a virtual image through an ‘display device-sized window’, which may be very small, for example 1 cm in diameter, at a relatively large distance, e.g., 1 metre. And the user will be viewing the display device-sized window via the pupil(s) of their eye(s), which can also be very small. Accordingly, the field of view becomes small and the specific angular range that can be seen depends heavily on the eye position, at any given time.

A pupil expander addresses the problem of how to increase the field of view—i.e., how to increase the range of angles of light rays that are propagated from the display device, and which can successfully propagate through an eye's pupil to form an image. The display device is (in relative terms) small and the projection distance is (in relative terms) large. In some embodiments, the projection distance is at least one—such as, at least two-orders of magnitude greater than the diameter, or width, of the entrance pupil and/or aperture of the display device (i.e., size of the array of pixels). Embodiments of the present disclosure described herein relate to a configuration in which a hologram of an image is propagated to the human eye rather than the image itself. In other words, the light received by the viewer is modulated according to a hologram of the image. However, other embodiments of the present disclosure may relate to configurations in which the image is propagated to the human eye rather than the hologram—for example, by so called indirect view, in which light of a holographic reconstruction or “replay image” formed on a screen (or even in free space) is propagated to the human eye.

The pupil expander increases the field of view and therefore increase the maximum propagation distance over which the full diffractive angle of the display device may be used. Use of a pupil expander can also increase the viewing area (i.e., user's eye-box) laterally, thus enabling some movement of the eye/s to occur, whilst still enabling the user to see the image. As the skilled person will appreciate, in an imaging system, the viewing area (user's eye box) is the area in which a viewer's eyes can perceive the image. The present disclosure generally relates to non-infinite virtual image distances—that is, near-field virtual images. However, the pupil expander of the present disclosure may be applied to forms of imaging, which may benefit from pupil expansion in a path that relays light between a display device and a viewing area.

Conventionally, the pupil expander comprises one or more one-dimensional optical waveguides each formed using bulk optics such as a block of glass or planar mirrors, in which the output light from a surface forms a viewing window—e.g., eye-box or eye motion box for viewing by the viewer. Light received from the display device (e.g., spatially modulated light from a LCOS) is replicated by the or each waveguide so as to increase the field of view (or viewing area) in at least one dimension. In particular, the waveguide enlarges the viewing window due to the generation of extra rays or “replicas” by division of amplitude of the incident wavefront. However, in order to achieve this, the display device must be in close proximity (e.g., adjacent) to the waveguide pupil expander(s). This places limitations on the overall configuration, size and volume of the display device, which prevents the design of a more compact device. Furthermore, the exit pupil of the pupil expander must be positioned so that the output light is relayed to a viewing area where a viewing system, such as a viewer's eyes, is positioned. This requirement, in combination with the size of the display device, limits its placement in situ. For example, when implemented as a head-up display for a driver in a vehicle, the display device must be placed within the vehicle dashboard at a location where the output light can be relayed to a viewing area where the driver's eyes are positioned.

The present disclosure proposes an alternative approach to pupil expansion. Instead of using one or more bulk optic pupil expanders in the relay path between the display device and the viewing area, pupil expansion is achieved using an arrangement comprising a plurality of optical fibres that form an “optical fibre pupil expander”. In particular, in accordance with the present disclosure, the output light of a display device is received by input ends of plurality of optical fibres. Output ends of the plurality of optical fibres are positioned to form an expanded exit window with an increased large field (i.e., increased range of angles of light rays propagated from the display device the viewer), and, in consequence, an increased viewing area for the viewing system. Thus, each optical fibre may be considered as replicating, or forming a replica of, at least a portion of the input light field so that the plurality of optical fibres forms a plurality of replicas for achieving pupil expansion in one or two dimensions. The term “replica” may be generally understood to refer to light rays that are output by a pupil expander over an expanded exit pupil as a result of the propagation (and division of amplitude) of input light, and the term “replicate” has a corresponding meaning. A more detailed definition of these terms is provided below.

As described above, the need for pupil expansion arises in display systems comprising a relatively small display device and a relatively large projection/propagation distance. Typically, the projection distance is at least one order of magnitude greater than aperture of the display device. In embodiments, the display system comprises a relatively small display device (e.g. a so-called “micro-display” of the order of 0.8 to 3 cm in diameter) and a viewing area at a relatively large propagation distance therefrom (e.g. 30 cm to 1.5 metres) so that, without pupil expansion, the field of view is limited for a given eye position. Thus, the optical fibre pupil expander of the present disclosure is particularly applicable to display systems comprising a micro-display (e.g. LCOS) with a viewing area separated by a relatively large distance therefrom, wherein the viewing area should allow a range of eye positions. Examples of such display systems include head-up displays for automotive and other applications, as described herein.

Whilst the present disclosure describes a plurality of optical fibres to achieve pupil expansion, the principles of the present disclosure may be implemented by substituting the optical fibres with any type of light guide or light pipe for propagating light from an input end to an output end by internal reflection (e.g., total internal reflection). Accordingly, references in the description to an “optical fibre pupil expander” are for convenience only and are not intended to limit the scope of the present disclosure.

There is provided a holographic system comprising a display device arranged to display a diffractive pattern, such as a hologram, of an image. The display device is further arranged to output light encoded (or modulated) with the diffractive pattern. The holographic system further comprises a pupil expander. The pupil expander comprises a plurality of light guides, each light guide having an input end and an output end. The pupil expander is arranged so that output light from the display device is coupled into the input end of each light guide and output from the output end thereof to a viewing area (at which a viewer can perceive the image). Each of the plurality of light guides is arranged to propagate the light received at its input end so as to expand an exit pupil of the system in a first dimension. The first dimension may correspond to a dimension of the viewing area.

In embodiments, the aperture of the spatial light modulator is the limiting aperture of the holographic system. That is, the aperture of the spatial light modulator-more specifically, the size of the area delimiting the array of light modulating pixels-determines the size (e.g. spatial extent) of the light ray bundle that can exit the system. In accordance with this disclosure, it is therefore stated that exit pupil of the holographic system is expanded by the array of optical fibres to reflect that the pupil expander effectively makes the exit pupil of the system larger/bigger. It may be said that each of the plurality of light guides is arranged to form a “replica” of the spatially modulated light received at its input end so as to expand the exit pupil of the holographic system. In some embodiments, the holographic light content output by the spatial light modulator is divided into light channels wherein each light guide receives light of one respective light channel and the plurality of light guides collectively deliver all the holographic light content to the viewer (e.g. at every possible viewing position). These embodiments are synergistic with the special type of channeling hologram that is described herein. In other embodiments, each light guide of the plurality of light guides increases the size of the exit pupil by forming a plurality of replicas or copies of the exit pupil (or light of the exit pupil) of the spatial light modulator. It may also be said that the plurality of light guides expand/increase the size of the received pupil. The spatial light modulator displays a hologram and it can therefore also be said that the pupil expander replicates the hologram or forms at least one replica of the hologram to reflect that the light delivered to the viewer is spatially modulated in accordance with a hologram of an image, not the image itself.

In embodiments, the output ends of the plurality of light guides are arranged in a one-dimensional array in the first dimension. In other embodiments, the output ends of the plurality of light guides are arranged in a two-dimensional array in the first and a second dimension, orthogonal to the first dimension.

In embodiments, light output from the output ends of the light guides is collimated (e.g., by a collimation lens) before it is relayed to the viewing system. Light may also be coupled into the input ends of the light guides by a respective lens.

In some embodiments, the display device is a holographic display device, such as a spatial light modulator (e.g., LCOS SLM) that spatially modulates light in accordance with a hologram. In embodiments described herein, light encoded with the hologram is output by the holographic display device to the optical fibre pupil expander (i.e., without forming an intermediate holographic reconstruction). Thus, a hologram of an image is propagated by the output light rather than the image itself.

In some examples, (modulated) light is coupled into the input ends of each of the plurality of light guides at the same time using a light guide splitter, such as an optical fibre splitter. In other embodiments, modulated light is coupled into the input ends of each of the plurality of light guides in time multiplexed fashion. That is, the (modulated) light is coupled into each of the plurality of light guides one at a time, in a defined sequence. In examples, the total duration of the sequence (i.e., for input of light to each and every one of the plurality of light guides) is less than the integration time of the human eye.

In still further embodiments, modulated light may be provided by the display device at a plurality of angles by encoding a so-called “channeling hologram” on the display device, as described herein. In some embodiments, the angles may be chosen so that light at each angle is coupled (or launched) into the input end of each of the plurality of light guides. That is, the input light field to each light guide is the same and comprises the (image) content of all the angular channels. Thus, each light guide replicates all angles/channels of the channeling hologram to provide pupil expansion. In other embodiments, the angles may be chosen so that light at each angle is coupled into the input end of a respective one of the plurality of light guides. Thus, the input light field to each of the plurality of light guides comprises (image) content of a respective one of the angular channels.

The same input light field may be coupled (or launched) into the input ends of at least two of the plurality of light guides, such that the at least two light guides replicate the same angle/channel of the channeling hologram to provide pupil expansion.

In some embodiments, the light guides carrying the same angle/channel have output ends that are adjacent in the array of output ends thereof, so that the replicas of the input light field thereof are contiguous. In still further embodiments, the angles may be chosen so that light of a subset of the angular channels is coupled into the input end of each of the plurality of light guides. Thus, the input light field of each of the plurality of light guides comprises (image) content of a subset of adjacent angular channels, and thus overlapping regions of (image) content of the subset of adjacent angular channels. The input light field of each angular channel (or subset) is coupled into the input ends of at least two of the plurality of light guides, such that the at least two light guides replicate the same angle/channel (or subset) of the channeling hologram to provide pupil expansion. In these embodiments, the light guides carrying the same or adjacent angular channels have output ends that are adjacent in the array of output ends thereof, so that the replicas of the light field of the respective angular channels are contiguous. In at least some of these embodiments, the modulated light may be coupled into the input ends of each of the plurality of fibre optics at the same time. Thus, each light guide replicates one or more respective angles/channels of the channeling hologram.

The disclosed novel technique for providing pupil expansion using a plurality of light guides has a number of advantages over conventional techniques using one or more bulk optic waveguides. In particular, the display device or light engine no longer needs to be adjacent to the exit window (e.g., in a vehicle dashboard) that provides light to the viewing system, such as a driver's eyes). In consequence, the size, volume and weight of the parts of the projection system in the dashboard can be reduced. Moreover, the light field received from the display device can be replicated and/or relayed along different groups of light guides, so as to provide respective exit windows to different viewing areas of the vehicle. In consequence, additional viewers, such as passengers, may be able to view images of the same holographic system without the need for additional complete holographic imaging system.

There is further provided a method of expanding an exit pupil of a holographic system. The method comprises displaying, by a display device, a diffractive pattern (e.g., hologram) of an image. The method further comprises outputting, by the display device, light encoded with (i.e., modulated with) the diffractive pattern. In embodiments, the display device is a spatial light modulator and the method comprises illuminating a spatial light modulator displaying the hologram so as to output spatially modulated light encoded with the hologram. The method further comprise coupling, by a pupil expander comprising a plurality of light guides, (modulated) light output by the display device into an input end of each of the plurality of light guides. The method further comprises propagating, by each of the plurality of light guides of the pupil expander, light received at its input end for output at its output end, in order to expand an exit pupil thereof in a first dimension. The first dimension may correspond to a dimension of a viewing area (at which a viewer can perceive the image).

The term “hologram” is used to refer to the recording which contains amplitude information or phase information, or some combination thereof, regarding the object. The recording of a hologram may be stored in a data storage device (i.e., memory) or embodied in light (e.g., as a light signal) forming a carrier wave for the amplitude and/or phase information. That is, the light may be described as being “encoded with a hologram” or “modulated in accordance with a hologram”, so as to propagate the hologram, rather than an image.

The term “holographic reconstruction” is used to refer to the optical reconstruction of the object which is formed by illuminating the hologram. A holographic reconstruction may also be referred to as a “replay image” or “holographic image”. Embodiments of the holographic system disclosed herein may be described as a “holographic projector” because the holographic reconstruction is a real image and spatially-separated from the hologram. The term “replay field” is used to refer to the 2D area within which the holographic reconstruction is formed and fully focused. If the hologram is displayed on a spatial light modulator comprising pixels, the replay field will be repeated in the form of a plurality diffracted orders wherein each diffracted order is a replica of the zeroth-order replay field. The zeroth-order replay field generally corresponds to the preferred or primary replay field because it is the brightest replay field. Unless explicitly stated otherwise, the term “replay field” should be taken as referring to the zeroth-order replay field. The term “replay plane” is used to refer to the plane in space containing all the replay fields. The terms “image”, “replay image” and “image region” refer to areas of the replay field illuminated by light of the holographic reconstruction. In some embodiments, the “image” may comprise discrete spots which may be referred to as “image spots” or, for convenience only, “image pixels”.

The terms “encoding”, “writing” or “addressing” are used to describe the process of providing the plurality of pixels of the SLM with a respective plurality of control values which respectively determine the modulation level of each pixel. It may be said that the pixels of the SLM are configured to “display” a light modulation distribution in response to receiving the plurality of control values. Thus, the SLM may be said to “display” a hologram and the hologram may be considered an array of light modulation values or levels.

It has been found that a holographic reconstruction of acceptable quality can be formed from a “hologram” containing only phase information related to the Fourier transform of the original object. Such a holographic recording may be referred to as a phase-only hologram. Embodiments relate to a phase-only hologram but the present disclosure is equally applicable to amplitude-only holography.

The present disclosure is also equally applicable to forming a holographic reconstruction using amplitude and phase information related to the Fourier transform of the original object. In some embodiments, this is achieved by complex modulation using a so-called fully complex hologram which contains both amplitude and phase information related to the original object. Such a hologram may be referred to as a fully-complex hologram because the value (grey level) assigned to each pixel of the hologram has an amplitude and phase component. The value (grey level) assigned to each pixel may be represented as a complex number having both amplitude and phase components. In some embodiments, a fully-complex computer-generated hologram is calculated.

Reference may be made to the phase value, phase component, phase information or, simply, phase of pixels of the computer-generated hologram or the spatial light modulator as shorthand for “phase-delay”. That is, any phase value described is, in fact, a number (e.g. in the range 0 to 2π) which represents the amount of phase retardation provided by that pixel. For example, a pixel of the spatial light modulator described as having a phase value of π/2 will retard the phase of received light by π/2 radians. In some embodiments, each pixel of the spatial light modulator is operable in one of a plurality of possible modulation values (e.g. phase delay values). The term “grey level” may be used to refer to the plurality of available modulation levels. For example, the term “grey level” may be used for convenience to refer to the plurality of available phase levels in a phase-only modulator even though different phase levels do not provide different shades of grey. The term “grey level” may also be used for convenience to refer to the plurality of available complex modulation levels in a complex modulator.

The hologram therefore comprises an array of grey levels—that is, an array of light modulation values such as an array of phase-delay values or complex modulation values. The hologram is also considered a diffractive pattern because it is a pattern that causes diffraction when displayed on a spatial light modulator and illuminated with light having a wavelength comparable to, generally less than, the pixel pitch of the spatial light modulator. Reference is made herein to combining the hologram with other diffractive patterns such as diffractive patterns functioning as a lens or grating. For example, a diffractive pattern functioning as a grating may be combined with a hologram to translate the replay field on the replay plane or a diffractive pattern functioning as a lens may be combined with a hologram to focus the holographic reconstruction on a replay plane in the near field.

Reference is made herein to a “complex light field”. The term “light field” merely indicates a pattern of light having a finite size in at least two orthogonal spatial directions, x and y. The word “complex” is used herein merely to indicate that the light at each point in the light field may be defined by an amplitude value and a phase value, and may therefore be represented by a complex number or a pair of values. For the purpose of hologram calculation, the complex light field may be a two-dimensional array of complex numbers, wherein the complex numbers define the light intensity and phase at a plurality of discrete locations within the light field. The complex light field may be propagated forward and back in the +z and −z directions between a hologram plane and an image plane. Light propagation can be simulated or modelled using any one of a number of different approaches or mathematical transforms familiar to the person skilled in the art of wave optics.

In the present disclosure, the term “replica” is merely used herein to reflect that spatially modulated light is divided such that a complex light field is directed along a plurality of different optical paths. The word “replica” is used to refer to each occurrence or instance of the complex light field after a replication event—such as a partial reflection-transmission by a pupil expander. Each replica travels along a different optical path. Some embodiments of the present disclosure relate to propagation of light that is encoded with a hologram, not image—i.e., light that is spatially modulated with a hologram of an image, not the image itself. The person skilled in the art of holography will appreciate that the complex light field associated with propagation of light encoded with a hologram will change with propagation distance. Use herein of the term “replica” is independent of propagation distance and so the two branches or paths of light associated with a replication event are still referred to as “replicas” of each other even if the branches are a different length such that the complex light field has evolved differently along each path. That is, two complex light fields are still considered “replicas” in accordance with this disclosure even if they are associated with different propagation distances-providing they have arisen from the same replication event or series of replication events.

Although different embodiments and groups of embodiments may be disclosed separately in the detailed description which follows, any feature of any embodiment or group of embodiments may be combined with any other feature or combination of features of any embodiment or group of embodiments. That is, all possible combinations and permutations of features disclosed in the present disclosure are envisaged.

### BRIEF DESCRIPTION OF THE DRAWINGS

Specific embodiments are described by way of example only with reference to the following figures:

FIG. 1 is a schematic showing a reflective SLM producing a holographic reconstruction on a screen.

FIG. 2A illustrates a first iteration of an example Gerchberg-Saxton type algorithm.

FIG. 2B illustrates the second and subsequent iterations of the example Gerchberg-Saxton type algorithm.

FIG. 2C illustrates alternative second and subsequent iterations of the example Gerchberg-Saxton type algorithm.

FIG. 3 is a schematic of a reflective LCOS SLM.

FIG. 4 shows angular content of a virtual image effectively propagating from a display device towards an aperture.

FIG. 5a shows a viewing system with a relatively small propagation distance.

FIG. 5b shows a viewing system with a relatively large propagation distance.

FIG. 6a shows a viewing system with a relatively large propagation distance, which includes a waveguide, for forming a virtual image at infinity.

FIG. 6b shows a magnified view of the optical paths of FIG. 6a.

FIG. 7 shows the optical system in accordance with embodiments.

FIG. 8 shows an image comprising a plurality of image areas (bottom) and corresponding hologram comprising a plurality of hologram components (top).

FIG. 9 shows a hologram, in accordance with the present disclosure, characterised by the routing or channeling of holographically encoded light into a plurality of discrete hologram channels.

FIG. 10 shows an optimised system arranged to route the light content of each hologram channel through a different optical path to the eye.

FIG. 11 is a schematic view of an optical fibre pupil expander in accordance with embodiments.

FIG. 12 is schematic view of a head-up display comprising the pupil expander of FIG. 11 positioned within a vehicle in accordance with an example.

The same reference numbers will be used throughout the drawings to refer to the same or like parts.

### DETAILED DESCRIPTION OF EMBODIMENTS

The present invention is not restricted to the embodiments described in the following but extends to the full scope of the appended claims. That is, the present invention may be embodied in different forms and should not be construed as limited to the described embodiments, which are set out for the purpose of illustration.

Terms of a singular form may include plural forms unless specified otherwise.

A structure described as being formed at an upper portion/lower portion of another structure or on/under the other structure should be construed as including a case where the structures contact each other and, moreover, a case where a third structure is disposed there between.

In describing a time relationship—for example, when the temporal order of events is described as “after”, “subsequent”, “next”, “before” or suchlike—the present disclosure should be taken to include continuous and non-continuous events unless otherwise specified. For example, the description should be taken to include a case which is not continuous unless wording such as “just”, “immediate” or “direct” is used.

Although the terms “first”, “second”, etc. may be used herein to describe various elements, these elements are not to be limited by these terms. These terms are only used to distinguish one element from another. For example, a first element could be termed a second element, and, similarly, a second element could be termed a first element, without departing from the scope of the appended claims.

Features of different embodiments may be partially or overall coupled to or combined with each other, and may be variously inter-operated with each other. Some embodiments may be carried out independently from each other, or may be carried out together in co-dependent relationship.

### Optical Configuration

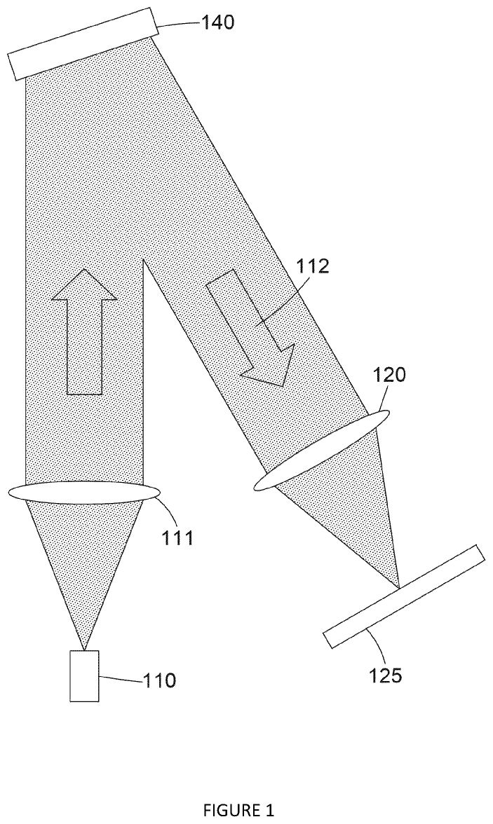

FIG. 1 shows an embodiment in which a computer-generated hologram is encoded on a single spatial light modulator. The computer-generated hologram is a Fourier transform of the object for reconstruction. It may therefore be said that the hologram is a Fourier domain or frequency domain or spectral domain representation of the object. In this embodiment, the spatial light modulator is a reflective liquid crystal on silicon, “LCOS”, device. The hologram is encoded on the spatial light modulator and a holographic reconstruction is formed at a replay field, for example, a light receiving surface such as a screen or diffuser.

A light source 110, for example a laser or laser diode, is disposed to illuminate the SLM 140 via a collimating lens 111. The collimating lens causes a generally planar wavefront of light to be incident on the SLM. In FIG. 1, the direction of the wavefront is off-normal (e.g. two or three degrees away from being truly orthogonal to the plane of the transparent layer). However, in other embodiments, the generally planar wavefront is provided at normal incidence and a beam splitter arrangement is used to separate the input and output optical paths. In the embodiment shown in FIG. 1, the arrangement is such that light from the light source is reflected off a mirrored rear surface of the SLM and interacts with a light-modulating layer to form an exit wavefront 112. The exit wavefront 112 is applied to optics including a Fourier transform lens 120, having its focus at a screen 125. More specifically, the Fourier transform lens 120 receives a beam of modulated light from the SLM 140 and performs a frequency-space transformation to produce a holographic reconstruction at the screen 125.

Notably, in this type of holography, each pixel of the hologram contributes to the whole reconstruction. There is not a one-to-one correlation between specific points (or image pixels) on the replay field and specific light-modulating elements (or hologram pixels). In other words, modulated light exiting the light-modulating layer is distributed across the replay field.

In these embodiments, the position of the holographic reconstruction in space is determined by the dioptric (focusing) power of the Fourier transform lens. In the embodiment shown in FIG. 1, the Fourier transform lens is a physical lens. That is, the Fourier transform lens is an optical Fourier transform lens and the Fourier transform is performed optically. Any lens can act as a Fourier transform lens but the performance of the lens will limit the accuracy of the Fourier transform it performs. The skilled person understands how to use a lens to perform an optical Fourier transform.

The embodiment of FIG. 1 may be used as part of holographic system in which the holographic reconstruction or replay image is relayed to a viewing area. As the skilled person will appreciate, in other embodiments the holographic system may be used in a holographic system in which the exit wavefront 112 is relayed to the viewing area without forming an intermediate holographic reconstruction.

### Hologram Calculation

In some embodiments, the computer-generated hologram is a Fourier transform hologram, or simply a Fourier hologram or Fourier-based hologram, in which an image is reconstructed in the far field by utilising the Fourier transforming properties of a positive lens. The Fourier hologram is calculated by Fourier transforming the desired light field in the replay plane back to the lens plane. Computer-generated Fourier holograms may be calculated using Fourier transforms.

A Fourier transform hologram may be calculated using an algorithm such as the Gerchberg-Saxton algorithm. Furthermore, the Gerchberg-Saxton algorithm may be used to calculate a hologram in the Fourier domain (i.e. a Fourier transform hologram) from amplitude-only information in the spatial domain (such as a photograph). The phase information related to the object is effectively “retrieved” from the amplitude-only information in the spatial domain. In some embodiments, a computer-generated hologram is calculated from amplitude-only information using the Gerchberg-Saxton algorithm or a variation thereof.

The Gerchberg Saxton algorithm considers the situation when intensity cross-sections of a light beam, I_{A}(x, y) and I_{B}(x, y), in the planes A and B respectively, are known and I_{A}(x, y) and I_{B}(x, y) are related by a single Fourier transform. With the given intensity cross-sections, an approximation to the phase distribution in the planes A and B, Ψ_{A}(x, y) and Ψ_{B}(x, y) respectively, is found. The Gerchberg-Saxton algorithm finds solutions to this problem by following an iterative process. More specifically, the Gerchberg-Saxton algorithm iteratively applies spatial and spectral constraints while repeatedly transferring a data set (amplitude and phase), representative of I_{A}(x, y) and I_{B}(x, y), between the spatial domain and the Fourier (spectral or frequency) domain. The corresponding computer-generated hologram in the spectral domain is obtained through at least one iteration of the algorithm. The algorithm is convergent and arranged to produce a hologram representing an input image. The hologram may be an amplitude-only hologram, a phase-only hologram or a fully complex hologram.

In some embodiments, a phase-only hologram is calculated using an algorithm based on the Gerchberg-Saxton algorithm such as described in British patent 2,498,170 or 2,501,112 which are hereby incorporated in their entirety by reference. However, embodiments disclosed herein describe calculating a phase-only hologram by way of example only. In these embodiments, the Gerchberg-Saxton algorithm retrieves the phase information Ψ[u, v] of the Fourier transform of the data set which gives rise to a known amplitude information T[x, y], wherein the amplitude information T[x, y] is representative of a target image (e.g. a photograph). Since the magnitude and phase are intrinsically combined in the Fourier transform, the transformed magnitude and phase contain useful information about the accuracy of the calculated data set. Thus, the algorithm may be used iteratively with feedback on both the amplitude and the phase information. However, in these embodiments, only the phase information Ψ[u, v] is used as the hologram to form a holographic representative of the target image at an image plane. The hologram is a data set (e.g. 2D array) of phase values.

In other embodiments, an algorithm based on the Gerchberg-Saxton algorithm is used to calculate a fully-complex hologram. A fully-complex hologram is a hologram having a magnitude component and a phase component. The hologram is a data set (e.g. 2D array) comprising an array of complex data values wherein each complex data value comprises a magnitude component and a phase component.

In some embodiments, the algorithm processes complex data and the Fourier transforms are complex Fourier transforms. Complex data may be considered as comprising (i) a real component and an imaginary component or (ii) a magnitude component and a phase component. In some embodiments, the two components of the complex data are processed differently at various stages of the algorithm.

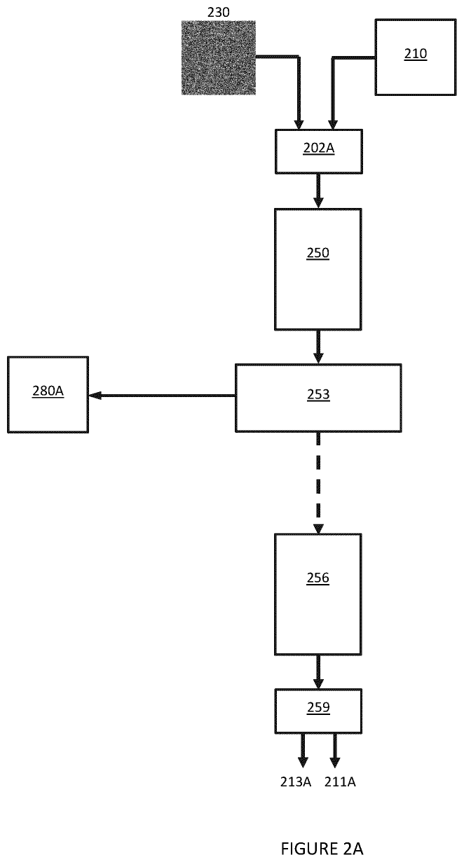

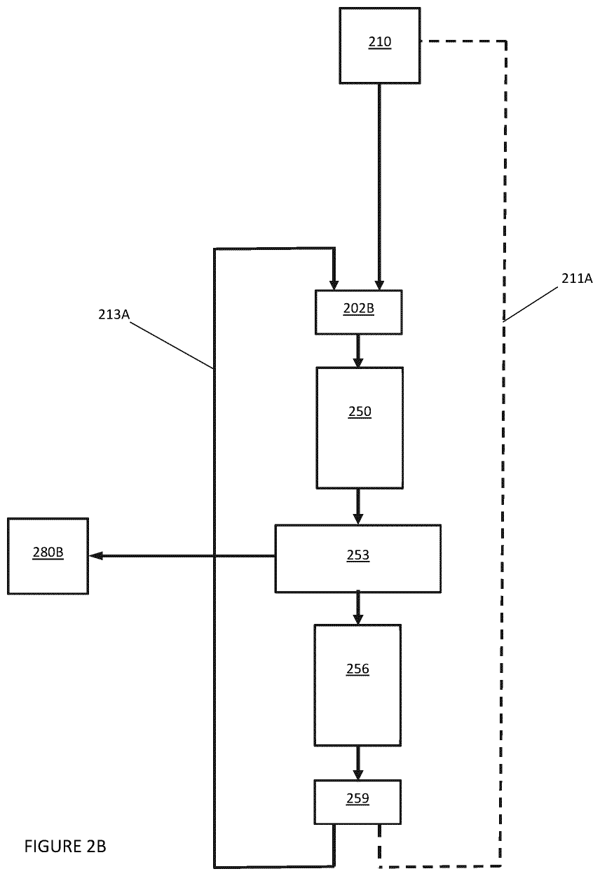

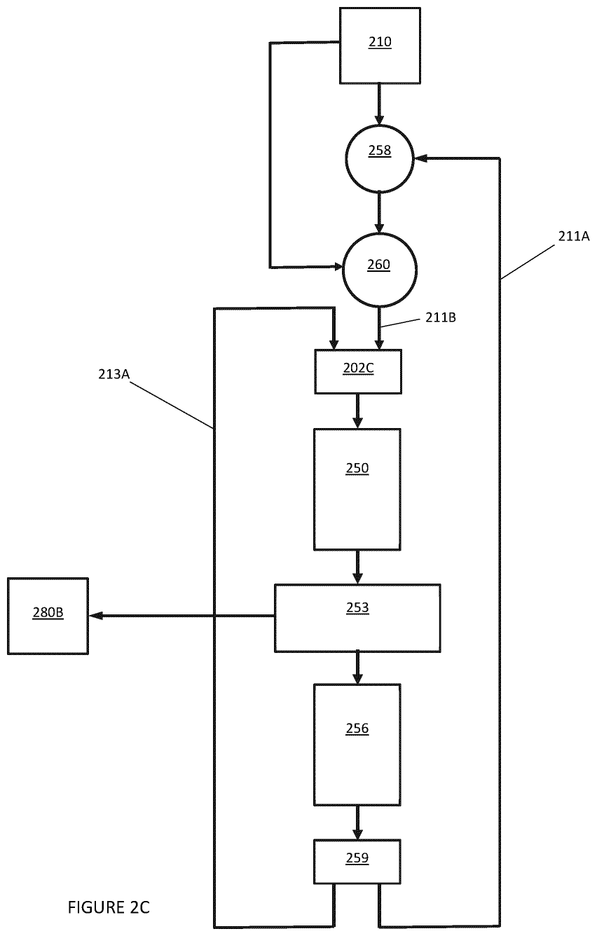

FIG. 2A illustrates the first iteration of an algorithm in accordance with some embodiments for calculating a phase-only hologram. The input to the algorithm is an input image 210 comprising a 2D array of pixels or data values, wherein each pixel or data value is a magnitude, or amplitude, value. That is, each pixel or data value of the input image 210 does not have a phase component. The input image 210 may therefore be considered a magnitude-only or amplitude-only or intensity-only distribution. An example of such an input image 210 is a photograph or one frame of video comprising a temporal sequence of frames. The first iteration of the algorithm starts with a data forming step 202A comprising assigning a random phase value to each pixel of the input image, using a random phase distribution (or random phase seed) 230, to form a starting complex data set wherein each data element of the set comprising magnitude and phase. It may be said that the starting complex data set is representative of the input image in the spatial domain.

First processing block 250 receives the starting complex data set and performs a complex Fourier transform to form a Fourier transformed complex data set. Second processing block 253 receives the Fourier transformed complex data set and outputs a hologram 280A. In some embodiments, the hologram 280A is a phase-only hologram. In these embodiments, second processing block 253 quantizes each phase value and sets each amplitude value to unity in order to form hologram 280A. Each phase value is quantised in accordance with the phase-levels which may be represented on the pixels of the spatial light modulator which will be used to “display” the phase-only hologram. For example, if each pixel of the spatial light modulator provides 256 different phase levels, each phase value of the hologram is quantised into one phase level of the 256 possible phase levels. Hologram 280A is a phase-only Fourier hologram which is representative of an input image. In other embodiments, the hologram 280A is a fully complex hologram comprising an array of complex data values (each including an amplitude component and a phase component) derived from the received Fourier transformed complex data set. In some embodiments, second processing block 253 constrains each complex data value to one of a plurality of allowable complex modulation levels to form hologram 280A. The step of constraining may include setting each complex data value to the nearest allowable complex modulation level in the complex plane. It may be said that hologram 280A is representative of the input image in the spectral or Fourier or frequency domain. In some embodiments, the algorithm stops at this point.

However, in other embodiments, the algorithm continues as represented by the dotted arrow in FIG. 2A. In other words, the steps which follow the dotted arrow in FIG. 2A are optional (i.e. not essential to all embodiments).

Third processing block 256 receives the modified complex data set from the second processing block 253 and performs an inverse Fourier transform to form an inverse Fourier transformed complex data set. It may be said that the inverse Fourier transformed complex data set is representative of the input image in the spatial domain.

Fourth processing block 259 receives the inverse Fourier transformed complex data set and extracts the distribution of magnitude values 211A and the distribution of phase values 213A. Optionally, the fourth processing block 259 assesses the distribution of magnitude values 211A. Specifically, the fourth processing block 259 may compare the distribution of magnitude values 211A of the inverse Fourier transformed complex data set with the input image 510 which is itself, of course, a distribution of magnitude values. If the difference between the distribution of magnitude values 211A and the input image 210 is sufficiently small, the fourth processing block 259 may determine that the hologram 280A is acceptable. That is, if the difference between the distribution of magnitude values 211A and the input image 210 is sufficiently small, the fourth processing block 259 may determine that the hologram 280A is a sufficiently-accurate representative of the input image 210. In some embodiments, the distribution of phase values 213A of the inverse Fourier transformed complex data set is ignored for the purpose of the comparison. It will be appreciated that any number of different methods for comparing the distribution of magnitude values 211A and the input image 210 may be employed and the present disclosure is not limited to any particular method. In some embodiments, a mean square difference is calculated and if the mean square difference is less than a threshold value, the hologram 280A is deemed acceptable. If the fourth processing block 259 determines that the hologram 280A is not acceptable, a further iteration of the algorithm may be performed. However, this comparison step is not essential and in other embodiments, the number of iterations of the algorithm performed is predetermined or preset or user-defined.

FIG. 2B represents a second iteration of the algorithm and any further iterations of the algorithm. The distribution of phase values 213A of the preceding iteration is fed-back through the processing blocks of the algorithm. The distribution of magnitude values 211A is rejected in favour of the distribution of magnitude values of the input image 210. In the first iteration, the data forming step 202A formed the first complex data set by combining distribution of magnitude values of the input image 210 with a random phase distribution 230. However, in the second and subsequent iterations, the data forming step 202B comprises forming a complex data set by combining (i) the distribution of phase values 213A from the previous iteration of the algorithm with (ii) the distribution of magnitude values of the input image 210.

The complex data set formed by the data forming step 202B of FIG. 2B is then processed in the same way described with reference to FIG. 2A to form second iteration hologram 280B. The explanation of the process is not therefore repeated here. The algorithm may stop when the second iteration hologram 280B has been calculated. However, any number of further iterations of the algorithm may be performed. It will be understood that the third processing block 256 is only required if the fourth processing block 259 is required or a further iteration is required. The output hologram 280B generally gets better with each iteration. However, in practice, a point is usually reached at which no measurable improvement is observed or the positive benefit of performing a further iteration is out-weighted by the negative effect of additional processing time. Hence, the algorithm is described as iterative and convergent.

FIG. 2C represents an alternative embodiment of the second and subsequent iterations. The distribution of phase values 213A of the preceding iteration is fed-back through the processing blocks of the algorithm. The distribution of magnitude values 211A is rejected in favour of an alternative distribution of magnitude values. In this alternative embodiment, the alternative distribution of magnitude values is derived from the distribution of magnitude values 211 of the previous iteration. Specifically, processing block 258 subtracts the distribution of magnitude values of the input image 210 from the distribution of magnitude values 211 of the previous iteration, scales that difference by a gain factor α and subtracts the scaled difference from the input image 210. This is expressed mathematically by the following equations, wherein the subscript text and numbers indicate the iteration number:

$${R}_{n + 1} [ x , y ] = {F}^{′} \{ exp ( i {ψ}_{n} [ u , v ] ) \}$$

$${ψ}_{n} [ u , v ] = ∠ F \{ η \cdot exp ( i ∠ {R}_{n} [ x , y ] ) \}$$

$$η = T [ x , y ] - α ( \vert {R}_{n} [ x , y ] \vert - T [ x , y ] )$$

where:
F′ is the inverse Fourier transform;
F is the forward Fourier transform;
R[x, y] is the complex data set output by the third processing block 256;
T[x, y] is the input or target image;
∠ is the phase component;
Ψ is the phase-only hologram 280B;
η is the new distribution of magnitude values 211B; and
α is the gain factor.

The gain factor α may be fixed or variable. In some embodiments, the gain factor α is determined based on the size and rate of the incoming target image data. In some embodiments, the gain factor α is dependent on the iteration number. In some embodiments, the gain factor α is solely function of the iteration number.

The embodiment of FIG. 2C is the same as that of FIG. 2A and FIG. 2B in all other respects. It may be said that the phase-only hologram Ψ(u, v) comprises a phase distribution in the frequency or Fourier domain.

In some embodiments, the Fourier transform is performed using the spatial light modulator. Specifically, the hologram data is combined with second data providing optical power. That is, the data written to the spatial light modulation comprises hologram data representing the object and lens data representative of a lens. When displayed on a spatial light modulator and illuminated with light, the lens data emulates a physical lens—that is, it brings light to a focus in the same way as the corresponding physical optic. The lens data therefore provides optical, or focusing, power. In these embodiments, the physical Fourier transform lens 120 of FIG. 1 may be omitted. It is known how to calculate data representative of a lens. The data representative of a lens may be referred to as a software lens. For example, a phase-only lens may be formed by calculating the phase delay caused by each point of the lens owing to its refractive index and spatially-variant optical path length. For example, the optical path length at the centre of a convex lens is greater than the optical path length at the edges of the lens. An amplitude-only lens may be formed by a Fresnel zone plate. It is also known in the art of computer-generated holography how to combine data representative of a lens with a hologram so that a Fourier transform of the hologram can be performed without the need for a physical Fourier lens. In some embodiments, lensing data is combined with the hologram by simple addition such as simple vector addition. In some embodiments, a physical lens is used in conjunction with a software lens to perform the Fourier transform. Alternatively, in other embodiments, the Fourier transform lens is omitted altogether such that the holographic reconstruction takes place in the far-field. In further embodiments, the hologram may be combined in the same way with grating data—that is, data arranged to perform the function of a grating such as image steering. Again, it is known in the field how to calculate such data. For example, a phase-only grating may be formed by modelling the phase delay caused by each point on the surface of a blazed grating. An amplitude-only grating may be simply superimposed with an amplitude-only hologram to provide angular steering of the holographic reconstruction. The second data providing lensing and/or steering may be referred to as a light processing function or light processing pattern to distinguish from the hologram data which may be referred to as an image forming function or image forming pattern.

In some embodiments, the Fourier transform is performed jointly by a physical Fourier transform lens and a software lens. That is, some optical power which contributes to the Fourier transform is provided by a software lens and the rest of the optical power which contributes to the Fourier transform is provided by a physical optic or optics.

In some embodiments, there is provided a real-time engine arranged to receive image data and calculate holograms in real-time using the algorithm. In some embodiments, the image data is a video comprising a sequence of image frames. In other embodiments, the holograms are pre-calculated, stored in computer memory and recalled as needed for display on a SLM. That is, in some embodiments, there is provided a repository of predetermined holograms.

Embodiments relate to Fourier holography and Gerchberg-Saxton type algorithms by way of example only. The present disclosure is equally applicable to Fresnel holography and Fresnel holograms which may be calculated by a similar method. The present disclosure is also applicable to holograms calculated by other techniques such as those based on point cloud methods.

### Light Modulation

A spatial light modulator may be used to display the diffractive pattern including the computer-generated hologram. If the hologram is a phase-only hologram, a spatial light modulator which modulates phase is required. If the hologram is a fully-complex hologram, a spatial light modulator which modulates phase and amplitude may be used or a first spatial light modulator which modulates phase and a second spatial light modulator which modulates amplitude may be used.

In some embodiments, the light-modulating elements (i.e. the pixels) of the spatial light modulator are cells containing liquid crystal. That is, in some embodiments, the spatial light modulator is a liquid crystal device in which the optically-active component is the liquid crystal. Each liquid crystal cell is configured to selectively-provide a plurality of light modulation levels. That is, each liquid crystal cell is configured at any one time to operate at one light modulation level selected from a plurality of possible light modulation levels. Each liquid crystal cell is dynamically-reconfigurable to a different light modulation level from the plurality of light modulation levels. In some embodiments, the spatial light modulator is a reflective liquid crystal on silicon (LCOS) spatial light modulator but the present disclosure is not restricted to this type of spatial light modulator.

A LCOS device provides a dense array of light modulating elements, or pixels, within a small aperture (e.g. a few centimetres in width). The pixels are typically approximately 10 microns or less which results in a diffraction angle of a few degrees meaning that the optical system can be compact. It is easier to adequately illuminate the small aperture of a LCOS SLM than it is the larger aperture of other liquid crystal devices. An LCOS device is typically reflective which means that the circuitry which drives the pixels of a LCOS SLM can be buried under the reflective surface. The results in a higher aperture ratio. In other words, the pixels are closely packed meaning there is very little dead space between the pixels. This is advantageous because it reduces the optical noise in the replay field. A LCOS SLM uses a silicon backplane which has the advantage that the pixels are optically flat. This is particularly important for a phase modulating device.

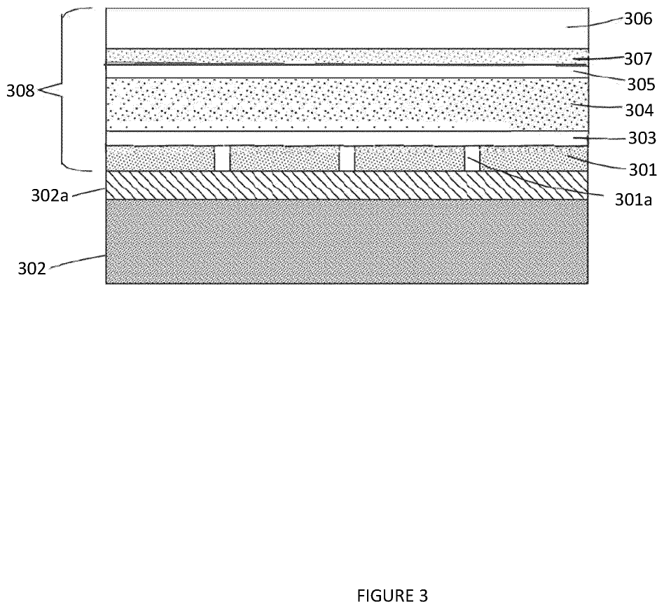

A suitable LCOS SLM is described below, by way of example only, with reference to FIG. 3. An LCOS device is formed using a single crystal silicon substrate 302. It has a 2D array of square planar aluminium electrodes 301, spaced apart by a gap 301a, arranged on the upper surface of the substrate. Each of the electrodes 301 can be addressed via circuitry 302a buried in the substrate 302. Each of the electrodes forms a respective planar mirror. An alignment layer 303 is disposed on the array of electrodes, and a liquid crystal layer 304 is disposed on the alignment layer 303. A second alignment layer 305 is disposed on the planar transparent layer 306, e.g. of glass. A single transparent electrode 307 e.g. of ITO is disposed between the transparent layer 306 and the second alignment layer 305.

Each of the square electrodes 301 defines, together with the overlying region of the transparent electrode 307 and the intervening liquid crystal material, a controllable phase-modulating element 308, often referred to as a pixel. The effective pixel area, or fill factor, is the percentage of the total pixel which is optically active, taking into account the space between pixels 301a. By control of the voltage applied to each electrode 301 with respect to the transparent electrode 307, the properties of the liquid crystal material of the respective phase modulating element may be varied, thereby to provide a variable delay to light incident thereon. The effect is to provide phase-only modulation to the wavefront, i.e. no amplitude effect occurs.

The described LCOS SLM outputs spatially modulated light in reflection. Reflective LCOS SLMs have the advantage that the signal lines, gate lines and transistors are below the mirrored surface, which results in high fill factors (typically greater than 90%) and high resolutions. Another advantage of using a reflective LCOS spatial light modulator is that the liquid crystal layer can be half the thickness than would be necessary if a transmissive device were used. This greatly improves the switching speed of the liquid crystal (a key advantage for the projection of moving video images). However, the teachings of the present disclosure may equally be implemented using a transmissive LCOS SLM.

### Image Projection Using a Small Display Device and a Long Viewing Distance

The present disclosure relates to image projection wherein the separation between the display device and viewer is much greater than the size of the display device. The viewing distance (i.e., distance between the viewer and display device) may be at least an order of magnitude greater than the size of the display device. The viewing distance may be at least two orders of magnitude greater than the size of the display device. For example, the pixel area of the display device may be 10 mm×10 mm and the viewing distance may be 1 m. The image projected by the system is formed on a display plane that is spatially separated from the display device.

In accordance with the present disclosure, the image is formed by holographic projection. A hologram is displayed on the display device. The hologram is illuminated by a light source (not shown) and an image is perceived on a display plane that is spatially separated from the hologram. The image may be real or virtual. For the purpose of the explanation that follows, it is helpful to consider a virtual image formed upstream of the display device. That is, appearing behind the display device. However, it is not essential that the image is a Virtual image and the present disclosure is equally applicable to a real image formed between the display device and viewing system.

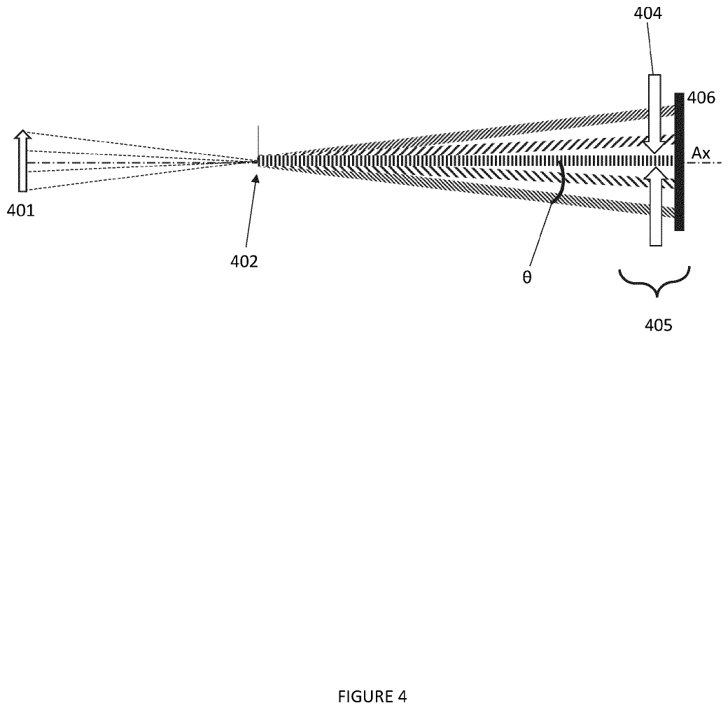

The display device comprises pixels that display the hologram. The pixel structure of the Display device is diffractive. The size of the holographic image is therefore governed by the rules of diffraction. A consequence of the diffractive nature of the display device is explained below with reference to FIG. 4.

FIG. 4 shows a pixelated display device 402 arranged to display a hologram forming a virtual image 401 upstream of the display device 402. The diffraction angle, q, of the display device determines the size of the virtual image 401. The virtual image 401, display device 402 and viewing system 405 are arranged on an optical axis, Ax.

The viewing system 405 has an entrance aperture 404 and viewing plane 406. The viewing system 406 may be a human eye. The entrance aperture 404 may therefore be the pupil of the eye and the viewing plane 406 may be the retina of the eye.

The light travelling between the display device 402 and viewing system 405 is modulated with a hologram of the image (not the image itself). However, FIG. 4 illustrates how the hologram divides the virtual image content by angle. Each illustrated light ray bundle relates to a different part of the virtual image 401. More specifically, the light in each light ray bundle is encoded by the hologram with information about one part of the virtual image. FIG. 4 shows five example ray bundles each characterized by a respective angle to the optical axis, Ax, and each representing a respective part of the virtual image. In this example, one of the light bundles passes through the pupil 404 and the other four light bundles are blocked by the pupil 404. Again, the five different ray bundles correspond to five different parts of the virtual image 401. The full image content of the virtual image is effectively divided by angle. The light bundle travelling along the optical axis, Ax, carries the centre part of the image information—that is, the information relating to the centre of the image. The other light bundles carry the other parts of the image information. The two light bundles shown at the extremes of the light cone carry the edge parts of the image information. A consequence of this division of the image information by angle is that not all image content can pass through the entrance aperture 404 of the viewing system at a given viewing position. In other words, not all image content is received by the eye. In the example of FIG. 4, only one of the five light bundles illustrated passes through the pupil 404 at any viewing position. The reader will understand that five light bundles are shown by way of example only and the process described is not limited to division of the image information of the virtual image into only five light bundles.

In this example, the centre part of the image information is received by the eye. The edge part of the image information is blocked by the pupil of the eye. The reader will understand that if the viewer moves up or down, a different light bundle may be received by the eye and, for example, the centre part of the image information may be blocked. The viewer therefore only sees a portion of the full image. The rest of the image information is blocked by the entrance pupil. The view of the viewer is heavily restricted because they are effectively looking at the image through the small aperture of the display device itself.

In summary, light propagates over the range of diffraction angle from the display device. At a 1 m viewing distance, only a small range of angles from the display device can propagate through the eye's pupil to form image at the retina for a given eye position. The only parts of the virtual image that are visible are the ones falling within the small angular range shown in FIG. 4 that passes through the entrance aperture. Accordingly, the field of view is very small, and the specific angular range depends heavily on the eye position.

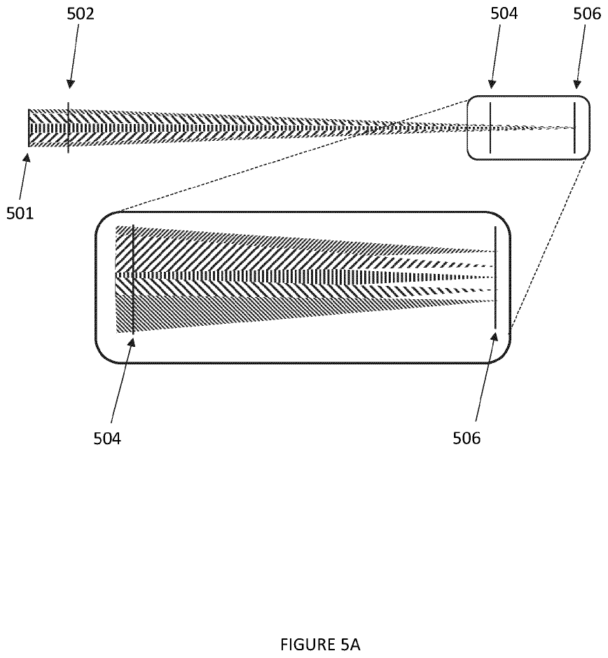

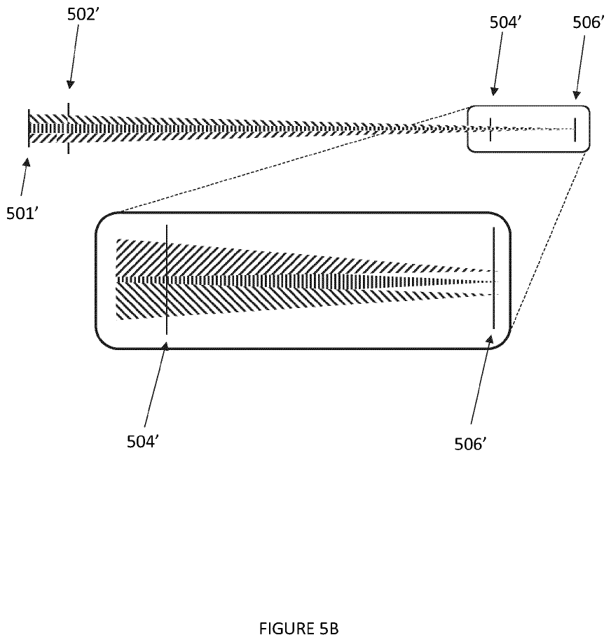

The problem of the small field of view and sensitivity to eye position explained with reference to FIG. 4 is a consequence of the large viewing distance and small aperture of the display device. The importance of viewing distance is explained further with reference to FIGS. 5 to 7.

FIG. 5A shows a display device 502 arranged to display a hologram and propagate light modulated in accordance with the hologram to a viewing system comprising an entrance aperture 504 and viewing plane 506. The virtual image 501 is at infinity and so the rays traced between the virtual image and display device are collimated. The lower part of FIG. 5A shows a magnified view of the viewing system. This figure is schematic and therefore physiological detail of the eye is not shown. In practice, there is, of course, a light source (not shown in FIG. 5A) arranged to illuminate the display device 502.

FIG. 5A only shows those rays of light that can propagate through the aperture 504; any other rays, which cannot pass through the aperture 504, are omitted. However, it will be understood that those other rays would also propagate from the display device 502, in practice. In FIG. 5A, the distance between the display device and viewing plane is small enough that the full diffraction angle from the display device can form the image on the retina. All light propagation paths shown from the virtual image pass through the entrance aperture. Accordingly, all points on the virtual image map onto the retina and all image content is delivered to the viewing plane. The field of view of the perceived image is therefore a maximum. At the optimum position, the field of view is equal to the diffraction angle of the display device. Interestingly, different image points on the retina are formed from light propagating from different regions on the display device 502—e.g., the image point closest to the top of FIG. 5A is formed from light propagating from the lower portion of the display device only. Light propagating from other regions of the display device does not contribute to this image point.

FIG. 5B shows the situation that arises as the viewing distance is increased.

In more detail, FIG. 5B shows a display device 502′ arranged to display a hologram and propagate light modulated in accordance with the hologram to a viewing system comprising an entrance aperture 504′ and viewing plane 506′. The virtual image 501′ is at infinity and so the rays traced between the virtual image and display device are collimated. The lower part of FIG. 5B shows a magnified view of the viewing system. This figure is schematic and therefore physiological detail of the eye is not shown. In practice, there is, of course, a light source (not shown in FIG. 5B) arranged to illuminate the display device 502′.

FIG. 5B only shows those rays of light that can propagate through the aperture 504′. At the larger viewing distance of FIG. 5B, some of the ray bundles are blocked by the entrance aperture 504′. Specifically, ray bundles associated with edge parts of the virtual image are blocked by the entrance pupil 504′. Accordingly, the entire virtual image is not visible and the part of the virtual image that is visible is heavily dependent on eye position. Thus, large distances between the display device and viewing system are problematic owing to the small size of the display device.

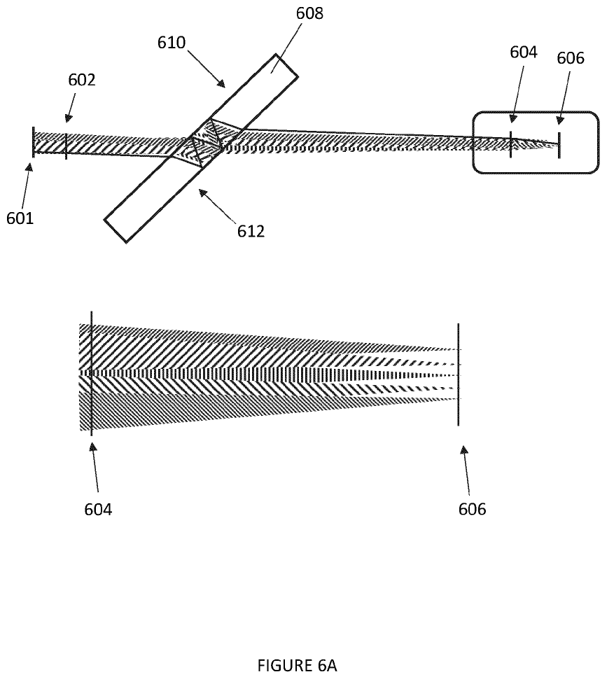

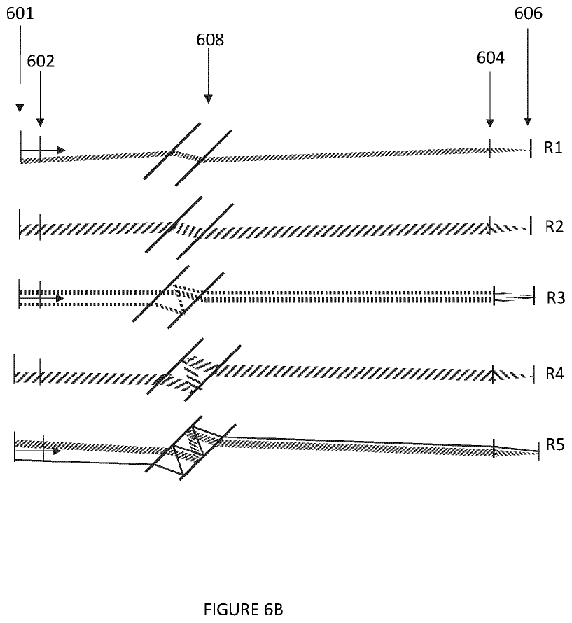

FIG. 6A shows an improved system comprising a display device 602, propagating light that has been encoded with a hologram displayed on the display device 602, towards a viewing system that comprises an entrance aperture 604 and a viewing plane 606. In practice, there is, of course, a light source (not shown) arranged to illuminate the display device 602. The improved system further comprises a bulk optic waveguide 608 positioned between the display device 602 and the entrance aperture 604. The lower part of FIG. 6A shows a magnified view of the entrance pupil 604 and the viewing plane 604. This figure is schematic and therefore physiological detail of the eye is not shown.

The viewing distance of FIG. 6 is the same as that of FIG. 5B. However, the ray bundles that were blocked in FIG. 5B are effectively recovered by the waveguide 608 such that the full image information is received by the viewing system-despite the longer viewing distance.

The presence of the waveguide 608 enables all angular content from the display device 602 to be received by the eye, even at this relatively large projection distance. This is because the waveguide 608 acts as a pupil expander, in a manner that is well known and so is described only briefly herein.

In brief, the bulk optic waveguide 608 comprises a substantially elongate formation having first and second planar (major) surfaces 610, 612. In this example, it comprises an optical slab of refractive material, but other types of waveguide, comprising a pair of parallel planar reflective surfaces, are also well known and may be used. The waveguide 608 is located so as to intersect the light cone that is projected from the display device 602, for example at an oblique angle. The size, location, and position of the waveguide 608 are configured to ensure that light from each of the five ray bundles, within the light cone, enters the waveguide 608. Light from the light cone enters the waveguide 608 via its first planar surface 610 (located nearest the display device 602) and is guided at least partially along the length of the waveguide 608, before being emitted via its second planar surface 612, substantially opposite the first surface 610 (located nearest the eye). As will be well understood, the second planar surface 612 is partially reflective, partially transmissive. In other words, when each ray of light travels, within the waveguide 608, from the first planar surface 610 to the second planar surface 612 of the waveguide 608, some of the light will be transmitted out of the waveguide 608 as a “replica” of the received light and some will be reflected by the second planar surface 612, back towards the first planar surface 610. The first planar surface 610 is reflective, such that all light that hits it, from within the waveguide 608, will be reflected back towards the second planar surface 612. Therefore, some of the light may simply be refracted between the two planar (major) surfaces 610, 612 of the waveguide 608 before being transmitted, whilst other light may be reflected, and thus may undergo one or more reflections, (or ‘bounces’) between the planar surfaces 610, 612 of the waveguide 608, before being transmitted. A net effect of the waveguide 608 is therefore that the transmission of the light is effectively expanded across multiple locations on the second planar surface 612 of the waveguide 608 by transmitting a series of replicas along its length. All angular content output by the display device 602 may thus be present, at a greater number of positions on the display plane (and at a greater number of positions on the aperture plane) than would have been the case, in the absence of the waveguide 608. This means that light from each ray bundle may enter the entrance aperture 604 and contribute to an image formed by the viewing plane 606, despite the relatively large projection distance. In other words, all angular content from the display device 602 can be received by the eye. Therefore, the full diffraction angle of the display device 602 is utilised and the viewing window is maximised for the user. In turn, this means that all the light rays contribute to the perceived virtual image 601.

FIG. 6B shows the individual optical paths for each of the five ray bundles that contribute to five respective image points within the virtual image 601 that is formed in FIG. 6A—labelled from top to bottom as R1 to R5, respectively. As can be seen therein, the light of each of R1 and R2 is simply refracted and then transmitted by the waveguide 608. The light of R4, on the other hand, encounters a single bounce before being transmitted. The light of R3 comprises some light from a corresponding first part of the display device 602 that is simply refracted by the waveguide 608 before being transmitted, and some light from a second, different corresponding part of the display device 602 that encounters a single bounce before being transmitted. Similarly, the light of R5 comprises some light from a corresponding first part of the display device 602 that encounters a single bounce before being transmitted and some light from a second, different corresponding part of the display device 602 that encounters two bounces before being transmitted. For each of R3 and R5, two different parts of the LCOS propagate light corresponding to that part of the virtual image.

The present inventors have recognised that, at least in some applications, it is preferable for the virtual image distance—i.e., for the distance from the viewer to the virtual image—to be finite, as opposed to the virtual image being formed at infinity. In certain applications, there will be a preferred virtual image distance, at which it is desirable or necessary for the virtual image content to appear. For example, this can be the case in a head-up display, for example in an automotive setting, for example if virtual image content is to be superimposed onto real content that is being viewed by the viewer through a vehicle windscreen. For example, a desired virtual image distance may comprise the virtual image content being formed a few metres, for example 3 metres or 5 metres, in front of the viewer's vehicle or windscreen.

### Hologram Calculation for Small Display Device, Long Viewing Distance and Pupil Expander

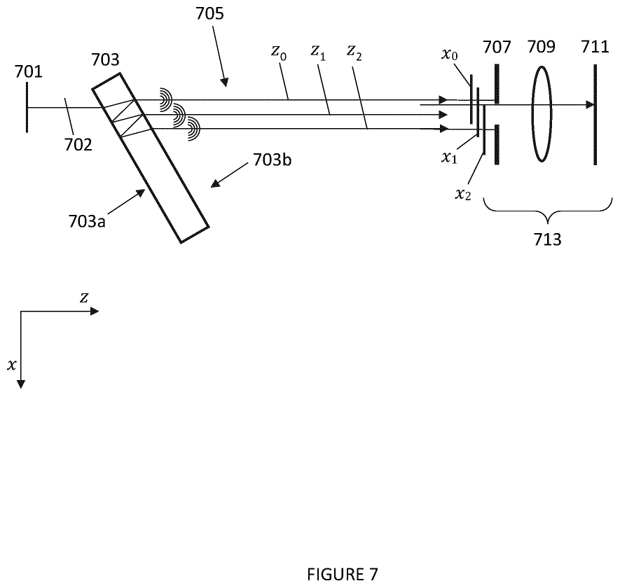

The inventors have previously devised a method of calculating a hologram for the optical system shown in FIG. 7 using a point cloud method, or using an iterative algorithm as disclosed in UK patent application numbers GB2101666.2, GB2101667.0 and GB2112213.0, which are incorporated herein by reference. This type of hologram is informally referred to herein as a “light channeling hologram” or simply “channeling hologram”. Importantly, the display device is relatively small and the projection distance is relatively long. The hologram is projected directly to the viewing system and the method is capable of implementation in real-time. The relatively small size of the display device and relatively long projection distance necessitate a pupil expander. The method addresses the different paths through the pupil expander. The method allows image content to appear at different distances from the viewing system and/or plural distances, optionally, at the same time—e.g., using one hologram. The method allows image content to appear downstream of the display device and upstream of the display device, optionally, at the same time—e.g., using one hologram.

FIG. 7 shows a spatial light modulator 701 operable to display a hologram of an image. In this embodiment, the spatial light modulator 701 is a liquid crystal on silicon device arranged to module the phase of received light. The spatial light modulator 701 is illuminated by at least partially coherent light from a light source not shown. The light source may be a laser diode. The spatial light modulator 701 outputs light that is spatially modulated in accordance with the display hologram. FIG. 7 shows one light ray 702 of the spatially modulated light. The spatially modulated light is received by a pupil expander 703. The pupil expander 703 is inclined relative to the plane of the display device 701. The pupil expander 703 therefore receives light at non-normal incidence. The incident angle (the angle the optical axis makes with the pupil expander) may be less than 25 degrees such as 10 to 20 degrees. The pupil expander comprises an input surface 703a that receives the spatially modulated light and an output surface 703b. The input surface 703a and output surface 703b are substantially parallel and elongate in a direction of pupil expansion. The input surface 703a comprises at least a portion that is substantially fully reflection (e.g., R=1). The output surface 703b comprises at least a portion that is highly reflective but partially transmissive (e.g., R=0.9 and T=0.1). The reflective surfaces are arranged such that spatially modulated light bounces back and forth therebetween, and light is emitted at a plurality of points along the output surface 703b, as described above with reference to waveguide 608 of FIG. 6. In this embodiment, the pupil expander is substantially elongate. The pupil expander provides pupil expansion in one—direction-namely, the elongate direction—but the present disclosure may be expanded to include the presence of a second pupil expander arranged to expand the pupil in an orthogonal direction.

FIG. 7 shows how light ray 702 has been effectively replicated twice to form three propagation paths 705 each associated with a different distance, Z₀, Z₁ and Z₂. The shortest propagation path corresponds to Z₀ and, in this example, light that has passed through the waveguide without any internal reflections. The middle-distance propagation path of the three shown corresponds to Z₁ and two internal reflections in the pupil expander (one by each surface). The longest propagation path shown corresponds to Z₂ and four internal reflections in the pupil expander (two by each surface). The planes x₀, x₁ and x₂ show the spatial extent of the light field associated with each of the three propagation paths, Z₀, Z₁ and Z₂, respectively. More specifically, FIG. 7 shows how the three planes x₀, x₁ and x₂ are offset from each other in the x-direction.

FIG. 7 further shows a viewing system 713 comprising an entrance pupil 707, a lens 709 and a light sensor 711. In embodiments, the viewing system 713 is a human eye and the light sensor 711 is the retina of the eye. FIG. 7 shows how only some of the light field associated with each propagation path passes through the entrance 707. FIG. 7 shows the light ray associated with centre of the middle-distance propagation path passing through the centre of the entrance pupil 707. But, for example, the light ray associated with the centre of the light field of shortest propagation path is blocked by a top portion of the aperture 707. However, other light rays associated with the light field of the shortest propagation path can pass through the aperture 707. The light ray associated with the centre of the light field of the longest propagation path is blocked by a lower portion of the aperture 707. However, other light rays associated with the light field of the longest propagation path can pass through the aperture 707 too.

Light passing through aperture 707 is focused by lens 709 onto the light sensor 711. The plane of the light sensor 711 is substantially parallel to the plane of the display device 701, and is therefore inclined relative to the elongate dimension of the pupil expander 703 too.

FIG. 7 shows three possible light propagation paths by way of example only. The present disclosure is not limited by the number of propagation paths. That is, as the skilled person will appreciate from the following description, the method may be extended to factor—in any number of light propagation paths. Likewise, it is not essential that the pupil expander is inclined relative to the display plane and sensor plane.

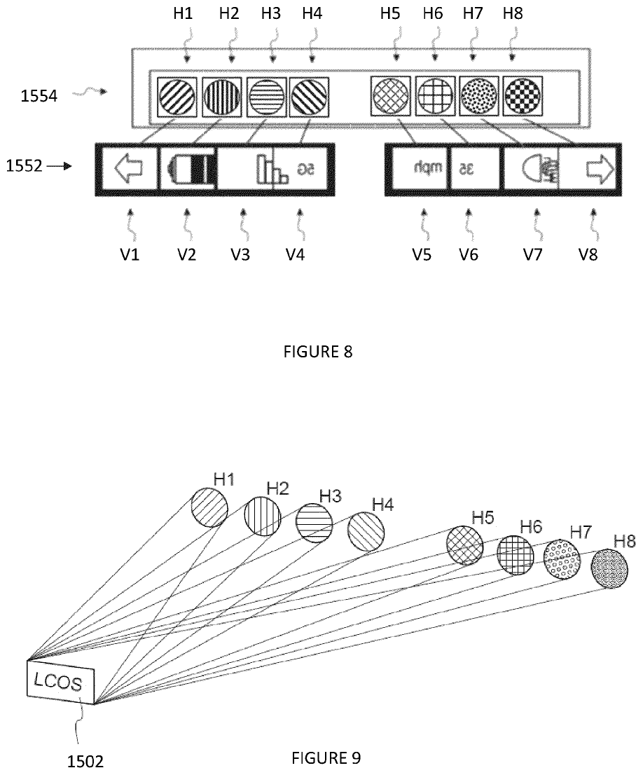

FIGS. 8 and 9 illustrate an example of a channeling hologram formed by a point cloud method, or a method using an iterative algorithm as disclosed in UK patent application numbers GB2101666.2, GB2101667.0 and GB2112213.0, supra.

### Light Channeling

FIG. 8 shows an image 1552 for projection comprising eight image areas/components, V1 to V8. FIG. 8 shows eight image components by way of example only and the image 1552 may be divided into any number of components. FIG. 8 also shows the encoded light pattern 1554 (i.e., hologram) that can reconstruct the image 1552—e.g., when transformed by the lens of a suitable viewing system. The encoded light pattern 1554 comprises first to eighth sub-holograms or components, H1 to H8, corresponding to the first to eighth image components/areas, V1 to V8. FIG. 8 further shows how this type of hologram effectively decomposes the image content by angle. The hologram may therefore be characterised by the channeling of light that it performs, and so is referred to as a “light channeling hologram” or simply “channeling hologram”. This is illustrated in FIG. 9. Specifically, the hologram in directs light into a plurality of discrete areas. The discrete areas are discs in the example shown but other shapes are envisaged. This channeling of light only occurs due to the specific method of determining the hologram.

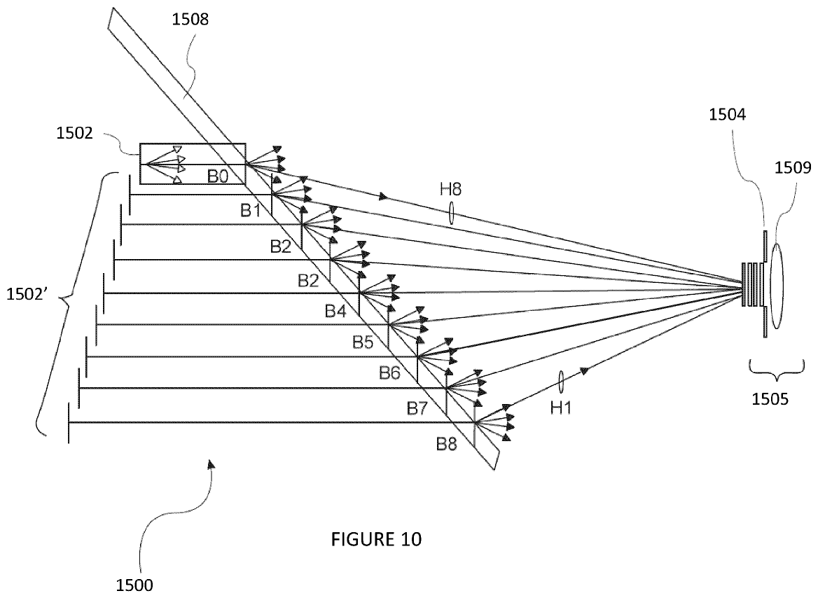

FIG. 10 shows an improved viewing system 1500, in accordance with the recognitions illustrated in FIGS. 8 and 9.

The viewing system 1500 comprises a display device, which in this arrangement comprises an LCOS 1502. The LCOS 1502 is arranged to display a modulation pattern (or ‘diffractive pattern’) comprising the hologram and to project light that has been holographically encoded towards an eye 1505 that comprises a pupil that acts as an aperture 1504, a lens 1509, and a retina (not shown) that acts as a viewing plane. There is a light source (not shown) arranged to illuminate the LCOS 1502. The lens 1509 of the eye 1505 performs a hologram to image transformation.

The viewing system 1500 further comprises a bulk optic waveguide 1508 positioned between the LCOS 1502 and the eye 1505. The projection distance in FIG. 10 may be relatively large. However, as described in relation to previous Figures, the presence of the waveguide 1508 enables all angular content from the LCOS 1502 to be received by the eye 1505, even at this relatively large projection distance. This is because the waveguide 1508 acts as a pupil expander, in a manner that has been described hereabove.

Additionally, in this arrangement, when the LCOS 1502 has been encoded with a channeling hologram, the waveguide 1508 can be oriented at an angle with respect to the LCOS 1502 in order to establish a unique relationship, between the light from the LCOS 1502 and the virtual image that the viewer will perceive. The size, location, and position of the waveguide 1508 are configured to ensure that light from each part of the virtual image enters the waveguide 1508 and is guided along its elongate axis, bouncing between the substantially planar surfaces of the waveguide 1508. Each time the light reaches the second planar surface (nearest the eye 1505), some light is transmitted and some light is reflected.

FIG. 10 shows a total of nine “bounce” points, B0 to B8, along the length of the waveguide 1502. The reader will notice that the centre of the image 1552 kept blank. FIG. 10 shows zeroth to ninth light “bounce” or reflection points, B0 to B8, within the waveguide. Although light relating to all points of the image (V1-V8) is transmitted out of the waveguide at each “bounce” from the second planar surface of the waveguide 1508, only the light from one of angular part of the image (e.g., light of one of V1 to V8) has a trajectory that enables it to reach the eye 1505, from each respective “bounce” point, B0 to B8. Moreover, light from a different angular part of the image, V1 to V8, reaches the eye 1505 from each respective “bounce” point. FIG. 10 shows light from all the different angular content being emitted at each “bounce” point, (depicted by a plurality of short arrows at each transmission point), but then only shows the optical path, to the eye 1505, of the respective angular content that will actually reach the eye 1505—and therefore will contribute to a respective portion of the virtual image that the viewer will perceive—from that respective part of the waveguide. For example, for the zeroth bounce, B0, the light that is transmitted by the waveguide 1508 is simply refracted and does not undergo any reflections therein. Light of the eighth sub-hologram, H8, reaches the eye from the zeroth bounce, B0. For the next bounce B1, the light that is transmitted by the waveguide 1502 undergoes one bounce therein, before transmission. Light from the seventh hologram, H7, reaches the eye from the next bounce, B1. This continues in sequence until the light that is transmitted by the waveguide 1508 at the final bounce, B8, has undergone eight bounces, before being transmitted and reaching the eye 1505, and comprises light encoded in accordance with the first hologram, H1.

In the example shown in FIGS. 10, light of only one image area reaches the eye from each bounce point. A spatial correlation between areas of the virtual image and their associated bounce point on the waveguide is therefore established-when the hologram is determined as described herein. In some other examples, there may be relatively small overlaps such that one region of the image comes from two adjacent transmission points, and thus is comprised within two adjacent discs of light that propagate from the waveguide, towards the viewing plane.

Thus, the recognitions made by the inventors, and the methods and arrangements described above can enable a diffractive pattern (or, light modulation pattern) comprising a hologram to be generated that, when displayed on an LCOS or other suitable display device, can enable the light to be emitted therefrom effectively in a plurality of ‘discs’, or ray bundles of light, each of which corresponds to (more specifically, encodes) a different respective part of the corresponding virtual image. As noted previously, in the present disclosure, this type of hologram is referred to as a “light channeling hologram” or simply “channeling hologram”.

### Optical Fibre Pupil Expansion

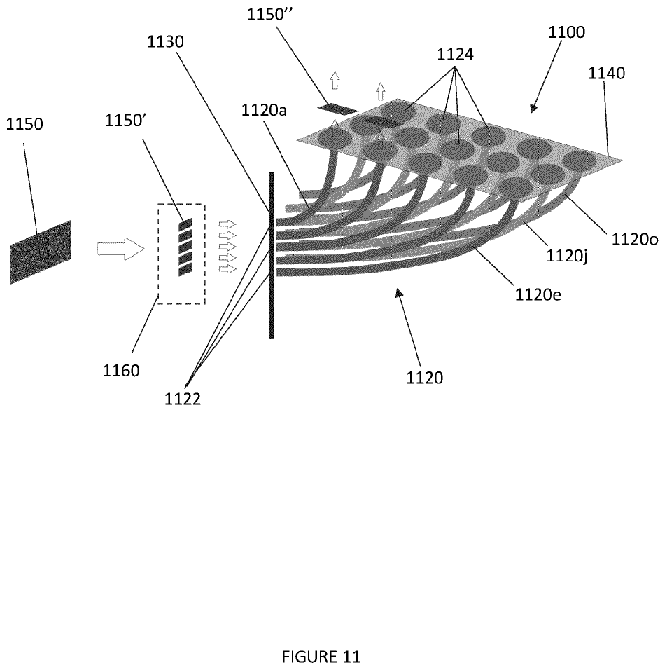

FIG. 11 is a schematic illustration of a novel technique for pupil expansion in accordance with embodiments the present disclosure. Instead of using bulk optics as the pupil expander/s, the technique uses a plurality of optical fibres (also called “fibre optics”). In other embodiments, the optical fibres may be replaced with other types of light guide or light pipe for propagating light from an input end to an output end.

The pupil expander 1100 is formed by a plurality of optical fibres 1120. Each optical fibre 1120 comprises an input end 1122 and an output end 1124. In the arrangement shown in FIG. 11, the input ends 1122 of the optical fibres 1120 are arranged in a two-dimensional array on an input plane 1130 of the pupil expander 1100, and the output ends 1124 of the optical fibres 1120 are arranged in a corresponding two-dimensional array on an output plane 1140 of the pupil expander 1100. As shown by arrows in FIG. 11, pupil expander 1100 is arranged to receive light from a hologram 1150 displayed on a display device to the input plane 1130 and output light towards a viewing area of a viewing system or viewer (not shown) from the output plane 1140.

Thus, (modulated) light output by display device, which is encoded with a hologram 1150, is coupled into the pupil expander 1100 by coupler 1160. In particular, coupler 1160 couples light into the input ends 1122 of the plurality of optical fibres 1120 at the input plane 1130. In some examples, a coupling lens or array of coupling lens may be disposed upstream of the input ends 1122 of the or each of the plurality of optical fibres 1120. Various techniques for coupling light into the pupil expander 1100 are possible, as described below. In addition, in some arrangements, light coupled into the respective input ends 1122 of each of the plurality of optical fibres may be the same (e.g., corresponding to the whole hologram 1150). Thus, all the optical fibres 1120 output light of the whole hologram at their output ends 1124 in the array at the output plane 1140 so as to form an array of “replicas” 1150″, and thus pupil expansion, thereof. In other arrangements, light coupled into the respective input ends 1122 of each of the plurality of optical fibres 1120 may be different (e.g., corresponding to a part of hologram 1150). In one example, light corresponding to only a respective part of a single hologram may be coupled into each optical fibre 1120 according to its position within the array (e.g., based on angular content such as a single channel or subset of channels of a channeling hologram). In this example, pupil expansion may be achieved by coupling light of each respective part of the hologram into two or more optical fibres 1120 having adjacent output ends 1124 in the array at the output plane 1140 so as to form contiguous “replicas” thereof. In another example, the plurality of optical fibres 1120 may receive light from a different hologram. In this example, each hologram may correspond to a different part of the image. Pupil expansion may be achieved by coupling light of each respective hologram into two or more optical fibres 1120 having adjacent output ends 1124 in the array at the output plane 1140 so as to form contiguous “replicas” thereof. The arrangement may be dynamically reconfigurable such that the pairings of holograms and fibres may change with time such as based on eye-tracking information (that is, information on the position of a viewer's eye/s within the viewing window). Thus, as shown in FIG. 11, coupler 1160 couples a separate channel of input light encoded with a respective hologram 1150′ (which may be the whole or part of hologram 1150) into the input end 1122 of each optical fibre 1120.

Each optical fibre 1120 is arranged to propagate the (modulated) light of the respective light channel received at its input end 1122 to its output end 1124, thereby effectively forming a “replica” 1150″ of light encoded with a hologram 1150′ (the same hologram or different holograms as described above). In particular, as the skilled person will appreciate, each optical fibre 1120 may propagate a complex input light field corresponding to a hologram 1150′ along its length by total internal reflection within the optical fibre's core. Thus, it is possible to control the complex output light field provided to a viewing area by the pupil expander 1110 from the output end 1124 of each optical fibre 1120 by controlling the hologram 1150. In some examples, the output ends 1124 of the or each of the plurality of optical fibres 1120 may be coupled to a lens. Thus, the light field output by the output plane 1140 of the pupil expander 1100 may be optically processed, such as collimated, before it is relayed to the viewing area according to application requirements.

In the arrangement shown in FIG. 11, the pupil expander 1100 comprises fifteen optical fibres 1110a-o having respective input 1122a-o and output 1124a-o ends arranged in a 3×5 array. It will be appreciated that, in other arrangement, any number of optical fibres 1110 may be used with the input and output ends thereof arranged in any desired one-dimensional array (for pupil expansion in one dimension) or two-dimensional array (for pupil expansion in two dimensions), according to application requirements.

In some embodiments, the plurality of optical fibres 1120 of the pupil expander 1100 is a bundle of optical fibres 1120 with the input end of the bundle, comprising the input ends 1122 of the optical fibres arranged in an array, at the input plane 1130 and the output end 1124 of the bundle, comprising output ends 1124 of the optical fibres arranged in an array, at the output plane 1140. In other embodiments, the plurality of optical fibres 1120 of the pupil expander is a plurality of individual multi-mode fibres with respective input ends 1122 and output ends 1124 arranged in an array, as described above. In still further embodiments, the plurality of optical fibres 1120 of the pupil expander 1100 is a bundle of multi-mode fibres with the input end of the bundle, comprising the input ends 1122 of the optical fibres arranged in an array, at the input plane 1130 and the output end of the bundle, comprising output ends 1124 of the optical fibres arranged in an array, at the output plane 1140. In other embodiments, each fibre is a single mode fibre.

A method of expanding an exit pupil of a holographic system using a pupil expander comprising a plurality of light guides, such as optical fibres, is provided. The method comprises displaying a diffractive pattern (e.g., hologram) of an image. For example, the diffractive pattern may be displayed by a spatial light modulator encoded or addressed with the hologram. The method may further comprise illuminating, by a light source, the diffractive pattern. The method further comprising outputting, by the diffractive pattern, light encoded with the hologram. For example, a spatial light modulator may be illuminated with light and output spatially modulated light in accordance with the hologram. The method further comprises coupling, into a pupil expander comprising a plurality of light guides, light encoded with the hologram into an input end of each of the plurality of light guides. For example, (modulated) light output by a spatial light modulator may be coupled, by a coupler, into an input end of each of the plurality of light guides of the pupil expander. The method further comprises propagating, by each of the plurality of light guides of the pupil expander, the light received at its input end for output at its output end in order to expand an exit pupil in a first dimension. The first dimension may correspond to a dimension of a viewing area (at which a viewer can perceive the image). In one example, the output ends of the plurality of light guides may be arranged in a one-dimensional array so as to expand an exit pupil along the dimension of the array. In another example, the output ends of the plurality of light guides may be arranged in a two-dimensional array so as to expand an exit pupil along both dimensions of the array.

As the skilled person will appreciate, the optical fibre pupil expander of the present disclosure may be used together with one or more conventional optical components, including optical/bulk optic waveguides, in the path of an optical system for relaying light from a display device to a viewing area for viewing by a viewing system, as described herein. For example, the optical fibre pupil expander may be used to expand the exit pupil in a first dimension for input into a waveguide pupil expander that expands the exit pupil in a second dimension, orthogonal to the first dimension.

Accordingly, it can be seen that a plurality of light guides, such as optical fibres, that may be bundled together in an array configuration as described herein, may perform pupil expansion in one or two dimensions, by the formation of “replicas” in the same way as conventional bulk optics. However, unlike bulk optics that can generally only expand the exit pupil in one dimension, an optical fibre pupil expander can expand the exit pupil in two dimensions at the same time by an arrangement of output ends in a two-dimensional array. Furthermore, a pupil expander comprising a plurality of light guides may be more flexibly positioned with respect to a display device and/or the viewing area of a (holographic) imaging system, for example by modifying the length and routing of the light guides in situ.

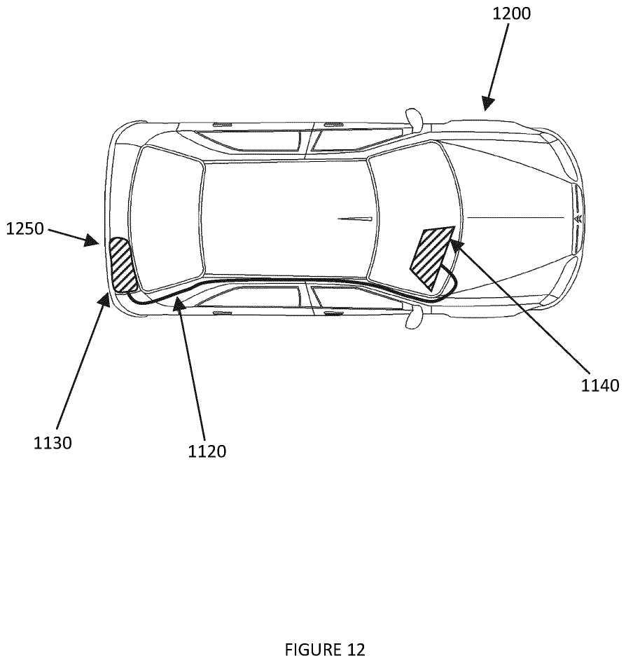

For example, as shown in FIG. 12, in a head-up display for a vehicle 1200, the display device 1250 may be positioned to the rear of the vehicle (e.g., in the boot/trunk), with an input plane 1130 of the pupil expander 1100 of the embodiment of FIG. 11 in proximity thereto, and the plurality of optical fibres 1120 of the pupil expander 1100 may extend along the sides of the vehicle 1200 to the output plane 1140 of the pupil expander 1100 in the vehicle dashboard. In this way, the head-up display consumes a reduced amount of the valuable space within the vehicle dashboard. In addition, it would be possible to provide a light channel feed from the display device 1250 via the (or a another) plurality of optical fibres 1120 to another location within the vehicle 1200, such as the vehicle dashboard on the front passenger's side for viewing by a passenger.

### Coupling Techniques

As noted above with reference to FIG. 11, various techniques may be used by coupler 1160 for coupling (modulated) light encoded with a hologram from a display device into the pupil expander 1100 comprising a plurality of optical fibres 1120.

In a first coupling technique, the same (modulated) light is coupled into the input ends 1122 of each of the plurality of fibre optics 1120 at the same time, for example using an optical fibre splitter (also called a “fibre optic splitter”). Thus, coupler 1160 may comprise a fibre optic splitter comprising an input port and a plurality of output ports corresponding to the number of optical fibres 1120 of the pupil expander 1100. The fibre optic splitter receives light encoded with the hologram 1150 from a display device (not shown) at its input port and “splits” the received light into a plurality of identical channels 1150′ for output from its output ports. The output ports of the fibre optic splitter may be configured at a plurality of angles so as to couple the respective output light channels into respective input ends 1122 of the array of input ends 1122 of the plurality of optical fibres 1120. Thus, every optical fibre 1120 receives the same (modulated) light at the same time. It may be said that the same hologram is launched at different angles into each of the optical fibres at the same time. Thus, the plurality of optical fibres 1120 form the same replica (i.e., replicate the same information/image content) at all positions of the expanded exit pupil at the output plane 1140 for relay towards the viewing area.

In a second coupling technique, the same (modulated) light is coupled into the input ends 1122 of each of the plurality of fibre optics 1120 in time multiplexed fashion. That is, the light is coupled into each of the plurality of optical fibre 1120 one at a time, in a defined sequence. Thus, coupler 1160 may comprise an input port, at least one output port and a multiplexer. The multiplexer sequentially couples the light from the/a respective output port (e.g., at different angles) into each of the plurality of optical fibres 1120 of the pupil expander 1100 in turn. This may be achieved using any suitable technique, such as using scanning mirrors or beam steering for outputting light at different angles from one output port, or by sequentially outputting light to a plurality of output ports arranged at different angles. Thus, every optical fibre 1120 receives the same encoded light but at different times in a time sequence. It may be said that the same hologram is launched at different angles into each of the optical fibres in sequence or time-multiplexed fashion. Thus, the plurality of optical fibres 1120 form the same replica (i.e., replicate the same information/image content) at all positions of the expanded exit pupil at the output plane 1140 for relay towards the viewing area, but at different times. In examples, the total duration of the sequence (i.e., time for input of light to every optical fibre forming the pupil expander) is less than the integration time of the human eye.

In some examples, the hologram 1150 itself distributes the necessary information down each optical fibre. That is, the hologram may be configured to route holographically-encoded light down each optical fibre of the plurality of optical fibres. The encoded light coupled into each optical fibre may contain hologram-domain information about the entire image or hologram-domain information about only a respective part (e.g. channel) of the image.

In a third coupling technique, different (modulated) light is coupled into the input ends 1122 of different ones of the plurality of optics fibres 1120, for example according to its respective position within the array. For example, a type of hologram, informally called a “channeling hologram”, as described below and in UK patent application numbers 2101666.2, GB2101667.0 and GB2112213.0, supra, may be calculated and displayed by the display device (not shown). By encoding a channeling hologram on the display device (not shown), the modulated light forms light channels that are output at a plurality of angles. The angles of the channeling hologram may be chosen so that light at each angle is coupled or launched into a respective one of the input ends 1122 of the plurality of optical fibres 1120 of the pupil expander 1100. Thus, different modulated light is coupled into input ends 1122 of different ones of the plurality of optical fibres 1120 at the same time. Two or more optical fibres 1120 having adjacent input/output ends may receive light of the same light channel or at the same angle for pupil expansion thereof as described herein. Light of a single light channel/angle or subset of (adjacent) light channels/angles may be coupled into each optical fibre 1120. Thus, a different hologram (e.g., different information) is coupled into each of the plurality of optical fibres 1120, according to the position of its input end 1122 within the array. In consequence, each optical fibre 1120 propagates a different part of the image (albeit in the hologram domain). It may be said that the plurality of optical fibres 1120 form different replicas or parts of the image (i.e., replicate or correspond to different information/image content) at different positions of the expanded exit pupil at the output plane 1140 for relay to the viewing area.

### Application of Optical Fibre Pupil Expander to Channeling Holograms

As described herein, optical fibre pupil expansion in accordance with the present disclosure may be implemented with a so-called channeling hologram, as described above and in UK patent application numbers GB2112216.3, GB2101667.0 and GB2112213, supra. As described above, a channeling hologram may be calculated that angularly distributes light (in the hologram domain) in accordance with position within the image and propagation of said light through a pupil expander providing a plurality of light propagation paths or “channels”, wherein each light propagation path corresponds to a respective continuous region of the image. Methods of calculating a channeling hologram effectively calculate a plurality of sub-holograms of each image and combine those sub-holograms to form the hologram for display. In embodiments, the image may be said to comprise a first image component and a second image component, wherein each image component is a different sub-area or sub-region of the image. That is, the image components are spatial components of the image—e.g. contiguous and/or continuous blocks of image pixels—that collectively make up the full image. However, in accordance with this disclosure, the image may be decomposed differently. That is, the “image components” may be different aspects or component elements of the image.

Thus, a channeling hologram may be calculated that angularly distributes light (in the hologram domain) such that a respective light channel (angular content) or subset thereof is coupled into a respective one of the plurality of optical fibres, in accordance with the position of input/output end thereof within the array of input/output ends of the plurality of optical fibres.

In some embodiments, an eye tracking system may be used to track the position of a viewer's eyes within the viewing area (e.g., eye motion box). In this case, the system may be arranged to dynamically control the coupling of the light channels into the plurality of optical fibres. Thus, when the viewer's eyes move within the eye motion box, the system may be arranged to reconfigure the allocation of angular content (i.e., image content) between the optical fibres based on eye-tracking data received as feedback, in order that the eye receives all angular content (i.e., all parts of the image).

### Additional Features

Embodiments refer to an electrically-activated LCOS spatial light modulator by way of example only. The teachings of the present disclosure may equally be implemented on any spatial light modulator capable of displaying a computer-generated hologram in accordance with the present disclosure such as any electrically-activated SLMs, optically-activated SLM, digital micromirror device or microelectromechanical device, for example.

In some embodiments, the light source is a laser such as a laser diode. The holographic projection system of the present disclosure may be used to provide an improved head-up display (HUD) or head-mounted display. In some embodiments, there is provided a vehicle comprising the holographic projection system installed in the vehicle to provide a HUD. The vehicle may be an automotive vehicle such as a car, truck, van, lorry, motorcycle, train, airplane, boat, or ship.

In embodiments, the holographic reconstruction is colour. In some embodiments, an approach known as spatially-separated colours, “SSC”, is used to provide colour holographic reconstruction. In other embodiments, an approach known as frame sequential colour, “FSC”, is used.

The method of SSC uses three spatially-separated arrays of light-modulating pixels for the three single-colour holograms. An advantage of the SSC method is that the image can be very bright because all three holographic reconstructions may be formed at the same time. However, if due to space limitations, the three spatially-separated arrays of light-modulating pixels are provided on a common SLM, the quality of each single-colour image is sub-optimal because only a subset of the available light-modulating pixels is used for each colour. Accordingly, a relatively low-resolution colour image is provided.

The method of FSC can use all pixels of a common spatial light modulator to display the three single-colour holograms in sequence. The single-colour reconstructions are cycled (e.g. red, green, blue, red, green, blue, etc.) fast enough such that a human viewer perceives a polychromatic image from integration of the three single-colour images. An advantage of FSC is that the whole SLM is used for each colour. This means that the quality of the three colour images produced is optimal because all pixels of the SLM are used for each of the colour images. However, a disadvantage of the FSC method is that the brightness of the composite colour image is lower than with the SSC method—by a factor of about 3-because each single-colour illumination event can only occur for one third of the frame time. This drawback could potentially be addressed by overdriving the lasers, or by using more powerful lasers, but this requires more power resulting in higher costs and an increase in the size of the system.

Examples describe illuminating the SLM with visible light but the skilled person will understand that the light sources and SLM may equally be used to direct infrared or ultraviolet light, for example, as disclosed herein. For example, the skilled person will be aware of techniques for converting infrared and ultraviolet light into visible light for the purpose of providing the information to a user. For example, the present disclosure extends to using phosphors and/or quantum dot technology for this purpose.

Some embodiments describe 2D holographic reconstructions by way of example only. In other embodiments, the holographic reconstruction is a 3D holographic reconstruction. That is, in some embodiments, each computer-generated hologram forms a 3D holographic reconstruction.

The methods and processes described herein may be embodied on a computer-readable medium. The term “computer-readable medium” includes a medium arranged to store data temporarily or permanently such as random-access memory (RAM), read-only memory (ROM), buffer memory, flash memory, and cache memory. The term “computer-readable medium” shall also be taken to include any medium, or combination of multiple media, that is capable of storing instructions for execution by a machine such that the instructions, when executed by one or more processors, cause the machine to perform any one or more of the methodologies described herein, in whole or in part.

The term “computer-readable medium” also encompasses cloud-based storage systems. The term “computer-readable medium” includes, but is not limited to, one or more tangible and non-transitory data repositories (e.g., data volumes) in the example form of a solid-state memory chip, an optical disc, a magnetic disc, or any suitable combination thereof. In some example embodiments, the instructions for execution may be communicated by a carrier medium. Examples of such a carrier medium include a transient medium (e.g., a propagating signal that communicates instructions).

It will be apparent to those skilled in the art that various modifications and variations can be made without departing from the scope of the appended claims. The present disclosure covers all modifications and variations within the scope of the appended claims and their equivalents.

What is claimed is:

1. A holographic system comprising:
a spatial light modulator arranged to display a hologram of an image and to output spatially modulated light encoded with the hologram; and
an optical fibre pupil expander comprising a plurality of optical fibres, each optical fibre having an input end and an output end, wherein the optical fibre pupil expander is arranged so that spatially modulated light output by the spatial light modulator is coupled into the input end of each optical fibre and output from the output end thereof to a viewing area, wherein each of the plurality of optical fibres is arranged to propagate the spatially modulated light received at its input end so as to expand an exit pupil of the holographic system in a first dimension, wherein the first dimension corresponds to a dimension of the viewing area.

2. The holographic system of claim 1, wherein each of the plurality of optical fibres is arranged to form a replica of the spatially modulated light received at its input end so as to expand the exit pupil in the first dimension.

3. The holographic system of claim 1, wherein the output ends of the plurality of optical fibres are arranged in a one-dimensional array in the first dimension.

4. The holographic system of claim 1, further comprising an optical fibre splitter arranged to couple the spatially modulated light output by the spatial light modulator into the input ends of each of the plurality of optical fibres at the same time.

5. The holographic system of claim 1, further comprising a multiplexer arranged to couple the spatially modulated light output by the spatial light modulator into each of the plurality of optical fibres one at a time, in a defined sequence, wherein a duration of the defined sequence is less than an integration time of a human eye.

6. The holographic system of claim 1, wherein the image comprises image information, and wherein the spatial light modulator is arranged to output spatially modulated light encoded with the hologram at a plurality of angles so that output light at each angle forms a respective light channel that is coupled into an input end of each, or a respective one or more of, the plurality of optical fibres, wherein each angular light channel comprises a part of the image information divided by angle.

7. The holographic system of claim 6, wherein each light channel is coupled into an input end of at least two optical fibres, wherein each of the at least two optical fibres replicates the respective light channel so as to expand the exit pupil in the first dimension, and optionally wherein each of the at least two optical fibres have adjacent output ends in the first dimension.

8. The holographic system of claim 6, wherein the holographic system is arranged to dynamically control an allocation of light channels to the plurality of optical fibres in response to feedback from an eye tracking system.

9. The holographic system of claim 1, wherein the exit pupil is additionally expanded in a second dimension, wherein the second dimension is orthogonal to the first dimension and, optionally, corresponds to a dimension of the viewing area.

10. The holographic system of claim 9, wherein the output ends of the plurality of optical fibres are arranged in a two-dimensional array in the first and second dimensions.

11. The holographic system of claim 1, further comprising a collimation lens arranged to collimate light output from the output ends of the optical fibres for relay to the viewing area.

12. The holographic system of claim 1, further comprising a light source arranged to illuminate the spatial light modulator so as to spatially modulate light in accordance with the hologram.

13. The holographic system of claim 1, wherein the spatial light modulator comprises a liquid crystal on silicon (“LCOS”) spatial light modulator, encoded with the hologram.

14. The holographic system of claim 1, further comprising magnification optics arranged to increase a range of available diffraction angles to the viewing area beyond a diffraction angle of the spatial light modulator.

15. The holographic system of claim 1, wherein the holographic system is arranged in a direct view configuration and the viewing area is an area for viewing the image a the human eye.

16. The holographic system of claim 1, wherein the viewing area is spatially separated from the spatial light modulator by a propagation distance of at least one order of magnitude greater than a width of an aperture of the spatial light modulator, wherein the propagation distance is in a range of 30 cm to 150 cm.

17. A head-up display comprising a holographic system, wherein the holographic system comprises:
a spatial light modulator arranged to display a hologram of an image and to output spatially modulated light encoded with the hologram; and
an optical fibre pupil expander comprising a plurality of optical fibres, each optical fibre having an input end and an output end, wherein the optical fibre pupil expander is arranged so that spatially modulated light output by the spatial light modulator is coupled into the input end of each optical fibre and output from the output end thereof to a viewing area, wherein each of the plurality of optical fibres is arranged to propagate the spatially modulated light received at its input end so as to expand an exit pupil of the holographic system in a first dimension, wherein the first dimension corresponds to a dimension of the viewing area, and wherein the viewing area comprises an eye-motion box.

18. A method of expanding an exit pupil of a holographic system, the method comprising:
displaying, by a spatial light modulator, a hologram of an image;
outputting, by the spatial light modulator, spatially modulated light encoded with the hologram;
coupling, by an optical fibre pupil expander comprising a plurality of optical fibres, spatially modulated light output by the spatial light modulator into an input end of each of the plurality of optical fibres; and
propagating, by each of the plurality of optical fibres of the optical fibre pupil expander, the spatially modulated light received at its input end for output at its output end, in order to expand an exit pupil of the holographic system in a first dimension, wherein the first dimension corresponds to a dimension of a viewing area.

19. A holographic system comprising:
a spatial light modulator arranged to display a hologram of an image and to output spatially modulated light encoded with the hologram; and
a plurality of optical fibres each having an input end and an output end, wherein the plurality of optical fibres is arranged so that spatially modulated light output by the spatial light modulator is coupled into the input end of each optical fibre and output from the output end thereof to a viewing area, wherein each of the plurality of optical fibres is arranged to form a replica of the spatially modulated light received at its input end such that the plurality of optical fibres expand an exit pupil in a first dimension.

20. A holographic system comprising:
a spatial light modulator arranged to display a hologram of an image and to output spatially modulated light encoded with the hologram comprising a plurality of light channels; and
a plurality of optical fibres each having an input end and an output end, wherein the plurality of optical fibres is arranged so that spatially modulated light, comprising one or more of the plurality of light channels output by the spatial light modulator, is coupled into the input end of each respective optical fibre and output from the output end thereof to a viewing area, wherein each of the plurality of optical fibres is arranged to propagate one or more respective light channels received at its input end such that the plurality of optical fibres expand an exit pupil in a first dimension.
